(19) United States
(12) Patent Application Publication
(10) Pub. No.: US 2017/0024733 A1
(43) Pub. Date: Jan. 26, 2017

(54) SEAMLESS TRANSACTION MINIMIZING USER INPUT

(71) Applicant: Thomas Purves, San Francisco, CA (US)

(72) Inventor: Thomas Purves, San Francisco, CA (US)

(21) Appl. No.: 14/804,191

(22) Filed: Jul. 20, 2015

(51) Int. Cl. G06Q 20/40; G06Q 20/32

(52) U.S. Cl. CPC G06Q 20/401; G06Q 20/322

(57) ABSTRACT

A user can utilize a first application to register their accounts with an alias identifier at an intermediary server computer. At a later time, the user may request access to information stored at the intermediary server computer to conduct a transaction with a certain resource providing entity for the first time. The resource providing entity may retrieve stored user data associated with the user and may send the user data to the intermediary server computer, which can determine accounts of the user based on the received user data and provide account options to the user for the transaction. This eliminates the need for the user to enter any account information into a device during the transaction.

### BACKGROUND

Traditionally, online transactions involve one or more instances in which a user enters account information. For example, when the user is utilizing an application providing services associated with multiple entities, each entity may require its own authorization process before allowing the user to access their service. This can result in the user entering multiple sets of credentials (e.g., username and password) during each transaction. This can be cumbersome because it can be difficult for the user to keep track of multiple credentials. Further, a transaction may unnecessarily take a longer time.

Illustratively, a user using an application associated with a first party may wish to access services associated with a second party. If the user tries to access the services through their application, the user may have to enter their credentials associated with the second party before proceeding. If the credentials are approved by the second party, the user may receive the services provided by the second party.

While the transaction process described above can be used, a number of improvements could be made. For instance, the conventional process is inefficient as it requires multiple instances of user input of credentials across services.

Thus, new and enhanced methods that minimize user input during transactions are desired. Embodiments of the invention address these and other problems, individually and collectively.

### BRIEF SUMMARY

Embodiments of the invention enable a seamless user experience for users shopping at multiple online resource providing entities and utilizing accounts associated with multiple authorization computers. A user can utilize a first application to register their accounts with an alias identifier at an intermediary server computer. At a later time, the user may request access to information stored at the intermediary server computer to conduct a transaction with a certain resource providing entity for the first time. The resource providing entity may retrieve stored user data associated with the user and may send the user data to the intermediary server computer, which can determine accounts of the user based on the received user data and provide account options to the user for the transaction. This eliminates the need for the user to enter any account information into a device during the transaction.

One embodiment of the invention is directed to a method comprising receiving, by a server computer, user data of a user conducting a transaction with a mobile device from a resource provider server computer. In some cases, the user data may include one or more alias identifiers associated with the user. The method further comprises determining, by the server computer, account data of the user by comparing the user data and enrollment data without receiving account information from the user during the transaction and sending account identifiers for the account data to the mobile device. The method further comprises receiving, by the server computer, a selection of an account identifier from the account identifiers and sending at least a portion of the account data corresponding to the selected account identifier to the resource provider server computer to utilize for the transaction.

In some embodiments, the method further comprises receiving, by the server computer prior to the transaction, the enrollment data from the mobile device and sending a request for the account data of the user to an authorization computer. The method further comprises receiving, by the server computer, the account data from the authorization computer and storing the account data in association with the enrollment data.

The mobile device utilized by the user may run one or more applications. In some embodiments, the enrollment data may be received from a mobile application associated with the authorization computer and the user may conduct the transaction by the mobile application associated with the resource provider server computer. In some cases, the mobile application associated with the resource provider server computer may receive a request for a personal identifier of the user from the mobile application associated with the authorization computer before the at least a portion of the account data is sent to the resource provider server computer. In some implementations, the personal identifier may be a biometric identifier.

Another embodiment of the invention is directed to a server computer comprising a processor and computer-readable medium coupled to the processor, where the computer-readable medium comprises code, executable by the processor, for performing a method. The method comprises receiving, by the server computer, user data of a user conducting a transaction with a mobile device from a resource provider server computer. In some cases, the user data may include one or more alias identifiers associated with the user. The method further comprises determining, by the server computer, account data of the user by comparing the user data and enrollment data without receiving account information from the user during the transaction and sending account identifiers for the account data to the mobile device. The method further comprises receiving, by the server computer, a selection of an account identifier from the account identifiers and sending at least a portion of the account data corresponding to the selected account identifier.

Another embodiment of the invention is directed to a method comprising contacting, by a mobile device, a resource provider server computer to conduct a transaction, wherein the resource provider server computer obtains user data associated with a user. The method further comprises receiving, by the mobile device, an indication from the user to communicate with an intermediary server computer, wherein the resource provider server computer transmits the user data to the intermediary server computer, and wherein the intermediary server computer determines account data of the user by comparing the user data and enrollment data without receiving account information from the user during the transaction. The method further comprises receiving, by the mobile device, account identifiers for the account data, receiving a selection of an account identifier from the account identifiers, and transmitting the selected account identifier to the intermediary server computer, wherein the intermediary server computer sends at least a portion of the account data corresponding to the selected account identifier to the resource provider server computer to utilize for the transaction.

In some embodiments, the method further comprises prompting, by the mobile device prior to the transaction, the user to enroll with the intermediary server computer and receiving the enrollment data from the user. The method further comprises receiving, by the mobile device, a personal identifier from the user, verifying that the personal identifier is valid, and sending the enrollment data to the intermediary server computer. In some implementations, the personal identifier may be a biometric identifier.

One embodiment of the invention is directed to a method comprising contacting, by a mobile device, a merchant server computer to conduct a transaction, wherein the merchant server computer obtains user data associated with a user. The method further comprises receiving, by the mobile device, an indication from the user to communicate with a digital wallet server, wherein the merchant server computer transmits the user data to the digital wallet server computer, and wherein the digital wallet server computer determines payment account data of the user by comparing the user data and digital wallet enrollment data without receiving account information from the user. The method further comprises receiving, by the mobile device, account identifiers for the payment account data and receiving a selection of an account identifier from the account identifiers. The method further comprises transmitting, by the mobile device, the selected account identifier to the digital wallet server computer, wherein the digital wallet server computer sends at least a portion of the payment account data corresponding to the selected account identifier to the merchant server computer to utilize for the transaction.

These and other embodiments of the invention are described in further detail below.

### BRIEF DESCRIPTION OF THE DRAWINGS

FIG. 1 shows a block diagram of an exemplary system according to embodiments of the invention.

FIG. 2 shows a block diagram of an exemplary mobile device according to embodiments of the invention.

FIG. 3 shows a block diagram of an exemplary merchant computer according to embodiments of the invention.

FIG. 4 shows an exemplary block diagram of a digital wallet server according to embodiments of the invention.

FIG. 5 shows an exemplary flow diagram of an enrollment process according to embodiments of the invention.

FIG. 6 shows an exemplary flow diagram of a transaction according to embodiments of the invention.

FIG. 7 shows an exemplary flow diagram of a transaction according to embodiments of the invention.

FIG. 8 shows an exemplary flow diagram of user interfaces displayed on a mobile device according to embodiments of the invention.

FIG. 9 shows an exemplary flow diagram of user interfaces displayed on a mobile device according to embodiments of the invention.

FIG. 10 is a block diagram for an exemplary computer system.

### DETAILED DESCRIPTION

Embodiments of the present invention are directed to systems, methods, apparatuses, and computer readable media for conducting a transaction that minimizes user input by a user. In some embodiments, the user may be conducting a transaction with a first mobile application on a mobile device, which may request access to services associated with a second mobile application. The second mobile application may be associated with an authorization computer that hosts one or more accounts associated with the user. An intermediary server computer may store account data received from the authorization computer in association with enrollment data received from a user during an enrollment process. During a transaction, the intermediary server computer may provide at least a portion of the account data to the first mobile application.

The enrollment data stored in the intermediary server computer may identify a user across multiple entities. For instance, the enrollment data may include an alias identifier (e.g., email address) of the user, which may be recognized by more than one entity (e.g., merchant and issuer) with which the user may be associated. Hence, if any user data matching the stored enrollment data is received during a transaction, the intermediary server computer may be able to identify the user and any information associated with the user.

Further, the intermediary server computer may conduct an enrollment process for one or more accounts of the user, where the accounts may be hosted by different entities. For example, the one more accounts may each be issued by a different issuer. Accordingly, the intermediary server computer may enable the user to utilize account data originating from different account issuers for a transaction, even when the user may not enter any account information during the transaction.

In some embodiments, the resource providing server computer may be a merchant computer, the intermediary server computer may be a digital wallet server, and the authorization computer may be an issuer computer. In other embodiments, the resource providing server computer, the intermediary server computer, and the authorization computer may be non-financial entities.

Prior to discussing embodiments of the invention, description of some terms may be helpful in understanding embodiments of the invention.

An “authorization request message” may be an electronic message that is sent to a payment processing network and/or an issuer of a payment account to request authorization for a payment transaction. An authorization request message according to some embodiments may comply with ISO 8583, which is a standard for systems that exchange electronic transaction information associated with a payment made by a consumer using a payment device or a payment account. An authorization request message may also comprise additional data elements corresponding to “identification information” including, for example, a service code, a CVV (card verification value), a dCVV (dynamic card verification value), an expiration date, etc. An authorization request message may also comprise “transaction data,” such as any information associated with a current transaction (e.g., the transaction amount, merchant identifier, merchant location, etc.) as well as any other information that may be utilized in determining whether to identify and/or authorize a payment transaction.

An “authorization response message” may be an electronic message reply to an authorization request message generated by an issuing financial institution (i.e. issuer) or a payment processing network. The authorization response message may include an authorization code, which may be a code that an account issuing bank returns in response to an authorization request message in an electronic message (either directly or through the payment processing network) to a merchant's access device (e.g., point of sale terminal) that indicates approval of the transaction. The code may serve as proof of authorization. As noted above, in some embodiments, a payment processing network may generate and/or forward the authorization response message to the merchant. In some embodiments, the authorization response message may be associated with confirmation element data by a confirmation element identifier. In some cases, modified confirmation element data may be included in the authorization response message sent to an access device.

A “server computer” may typically be a powerful computer or cluster of computers. For example, the server computer can be a large mainframe, a minicomputer cluster, or a group of servers functioning as a unit. In one example, a server computer may be a database server coupled to a Web server. The server computer may be associated with an entity such as a merchant, payment processing network, a wallet provider, a merchant, an authentication cloud, an acquirer, or an issuer.

A “computing device” may be any suitable electronic device that can process and communicate information to other electronic devices. The computing device may include a processor and a computer readable medium coupled to the processor, the computer readable medium comprising code, executable by the processor. The computing device may also each include an external communication interface for communicating with each other and other entities. A mobile device may be a type of computing device.

An “authorization computer” can include any system involved in authorization of a transaction. The authorization computer may determine whether a transaction can be authorized and may generate an authorization response message including an authorization status (also may be known as an authorization decision). In some embodiments, an authorization computer may be a payment account issuer computer. In some cases, the authorization computer may store contact information of one or more users. In other embodiments, the authorization computer may authorize non-financial transactions involving a user. For example, the authorization computer may make an authorization decision regarding whether the user can access a certain resource (e.g., an electronic document). In some cases, the authorization may be a content provider server computer associated with a content providing entity, which manages one or more resources that may be accessed by the user.

“A resource providing entity” may be an entity that may make resources available to a user. Examples of resource providing entities include merchants, vendors, suppliers, owners, traders, and the like. In some embodiments, such entities may be a single individual, small groups of individuals, or larger groups of individuals (e.g., companies). Resource providing entities may be associated with one or more physical locations (e.g., supermarkets, malls, stores, etc.) and online platforms (e.g., mobile applications, e-commerce websites, online companies, etc.). In some embodiments, resource providing entities may make available physical items (e.g., goods, products, etc.) to the user. In other embodiments, resource providing entities may make available digital resources (e.g., electronic documents, electronic files, etc.) to the user. In other embodiments, resource providing entities may manage access to certain resources by the user.

A “resource provider server computer” may include any system associated with a resource providing entity. In some embodiments, the resource provider server computer may handle functionality of a mobile application associated with the resource providing entity. A user may conduct a transaction using the mobile application.

An “intermediary server computer” may include any system involved in handling information received from one or more entities. For example, the intermediary server computer may receive and store data associated with a user from a first entity and further data associated with the user from a second entity. In some embodiments, the intermediary server computer may receive and store enrollment data of a user from a first entity and account data of a user from a second entity. In one exemplary case, the intermediary server computer may be a digital wallet server, which may store enrollment data of the user and account data associated with one or more accounts with the user. In other cases, the intermediary server computer may be any cloud account, which may store enrollment data of the user and account data associated with one or more accounts with the user.

A “personal identifier” may include any series of characters, numbers, graphics, symbols, or other information that may be provided by a user. Typically, a personal identifier is utilized to uniquely identify the user during authentication or authorization processes that deal with sensitive data. For instance, biometric identifiers (e.g., fingerprint, voiceprint, facial scans, retinal scans, etc.) may be examples of personal identifiers that can uniquely identify a user. A personal identifier may increase security of a transaction, since it can be utilized to confirm a user's identity before distribution of services or resources.

“User data” may refer to any information surrounding a user conducting a transaction. User data may include alias identifiers (e.g., email address, phone number, etc.) associated with the user and device identifiers (e.g., cookies) associated with a mobile device operated by the user. In some cases, user data may also include a name, contact information, and a location associated with the user. In some embodiments, user data may be stored at a mobile device of the user and by other entities, such as a resource provider server computer.

“Account data” may refer to any content of an account of a user conducting a transaction. In some embodiments, account data may be payment account data that may be utilized to make a purchase. In other embodiments, account data may be any content associated with a user's non-financial account. For example, account data may include electronic files, photos, videos, and documents stored by the user's account. In some embodiments, account data may be stored by an authorization computer.

An “account identifier” may refer to include any series of characters, numbers, graphics, symbols, or other information that may uniquely represent an account. In some embodiments, each account of a user may correspond to a different account identifier. In some cases, an account identifier may be an account number, partial account number, account nickname, or virtual card art. In other cases, an account identifier may be a personalized logo, profile picture, or username.

“Account information” may refer to any information surrounding an account of a user. For example, account information may include account data and one or more account identifiers. In some embodiments, “account information” may include payment account information. Payment account information may include account identifiers (e.g., account numbers), verification values (CVV, CVV2, dCVV, and dCVV2 values, service codes, expiration dates, etc.).

“Enrollment data” may refer to any information provided by a user during a registration process. Enrollment data may also be referred to by any suitable name, such as registration data, registration information, and enrollment information. Enrollment data may include any user data that may be stored by a user's mobile device or can be entered by the user into their mobile device. Enrollment data may include information (e.g., alias identifiers, etc.) that can uniquely identify the user when stored by another entity.

“Transaction details” may refer to any data or information surrounding or related to a transaction. For example, transaction details may include any data associated with the transaction that may be utilized by entities involved in the transaction process. For instance, the transaction details may include information useful for processing and/or verifying the transaction. Transaction details may also include any data or information surrounding or related to any participants partaking in or associated with the transaction. Example transaction details may include a transaction amount, transaction location, resources received or accessed (e.g., products, documents, etc.), information about the resources received or accessed (e.g., name, size, amount, type, etc.), resource providing entity data (e.g., merchant data, resource owner data, etc.), user data, date and time of a transaction, payment method, and other relevant information.

### I. Exemplary Systems and Methods

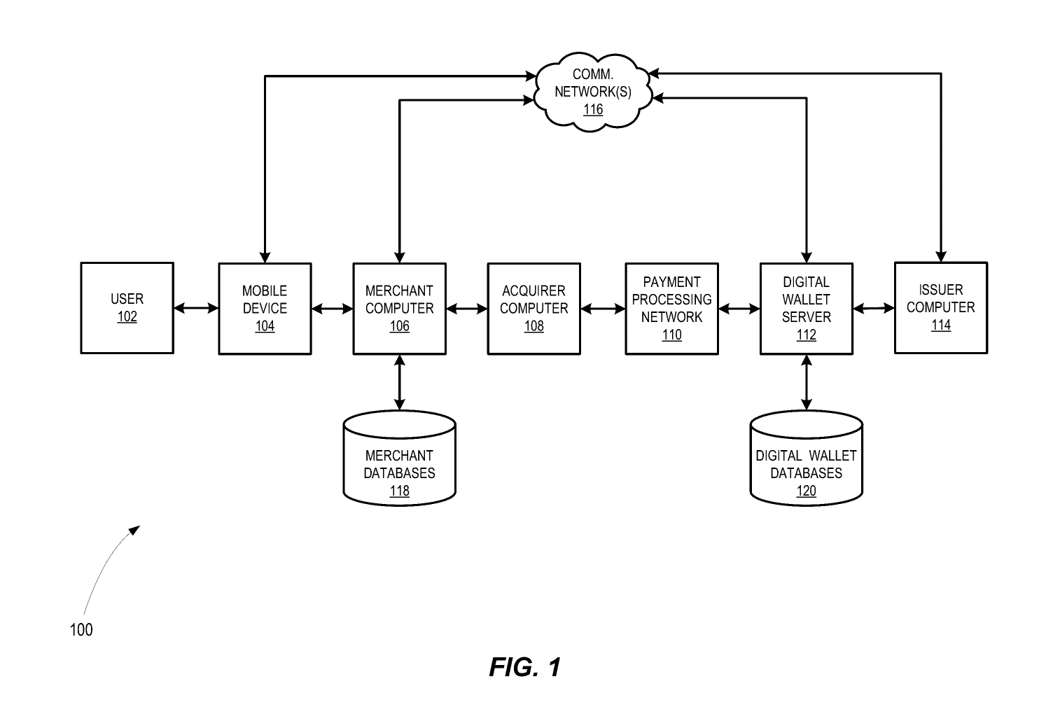

FIG. 1 shows a block diagram of a system 100 according to an embodiment of the invention. The system 100 is for enabling a user to conduct transactions with their digital wallets across multiple merchant applications and issuer applications with minimal user input. The system 100 includes a user 102 that may operate a mobile device 104, a merchant computer 106, an acquirer computer 108, a payment processing network 110, a digital wallet server 112, and an issuer computer 114. Mobile device 104, merchant computer 106, acquirer computer 108, payment processing network 110, digital wallet server 112, and issuer computer 114 may be in operative communication with each other by any suitable communications network, such as communications network 116.

For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the internet), using any suitable communications protocol.

User 102 (which may alternatively be referred to as a consumer) may operate mobile device 104. User 102 may communicate with other entities by entering information into mobile device 104. For example, user 102 may enter user data into an interface on mobile device 104, which can send the entered data over communications network 116. In some embodiments, user 102 may provide user data (e.g., email address, phone number, etc.) to mobile device 104.

Mobile device 104 may be in any suitable form. Mobile device 104 may be a type of computing device. For example, a suitable mobile device 104 can be hand-held and compact so that it can fit into a consumer's pocket (e.g., pocket-sized). Mobile device 104 can include a processor, a memory, input devices, and output devices, operatively coupled to the processor. Some non-limiting examples of mobile device 104 may include mobile devices (e.g., cellular phones, keychain devices, personal digital assistants (PDAs), pagers, notebooks, laptops, notepads, wearable devices (e.g., smart watches, fitness bands, jewelry, etc.), automobiles with remote communication capabilities, personal computers, payment cards (e.g., smart cards, magnetic stripe cards, etc.), and the like. Mobile device 104 may be associated with a consumer or a user, such as user 102.

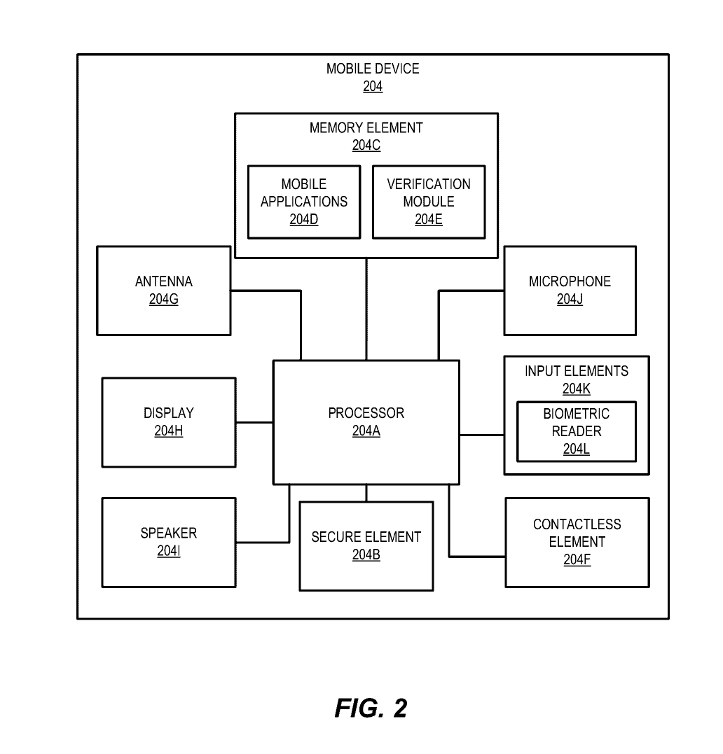

In some embodiments, mobile device 104 may include one or more mobile applications stored in a memory or secure element of mobile device 104. In some embodiments, mobile device 104 may include a first mobile application associated with a resource providing entity (e.g., merchant) and a second mobile application associated with an authorization computer (e.g., issuer). User 102 may utilize the first mobile application to conduct transactions and may utilize the second mobile application to maintain one or more payment accounts. In some embodiments, the mobile applications may be interfaces on a host's website (e.g., merchant website, issuer website, etc.) that allows user 102 to enter data (e.g., payment data) for submission for processing a transaction. FIG. 2 describes various components of an exemplary mobile device in further detail.

Merchant computer 106 may be configured to receive and transmit transaction data. Merchant computer 106 may be associated with a merchant that may engage in transactions, sell goods or services, or provide access to goods or services to the consumer and that may operate a physical store and use an access device for in-person transactions. Merchant computer 106 may accept multiple forms of payment and may use multiple tools to conduct different types of transactions.

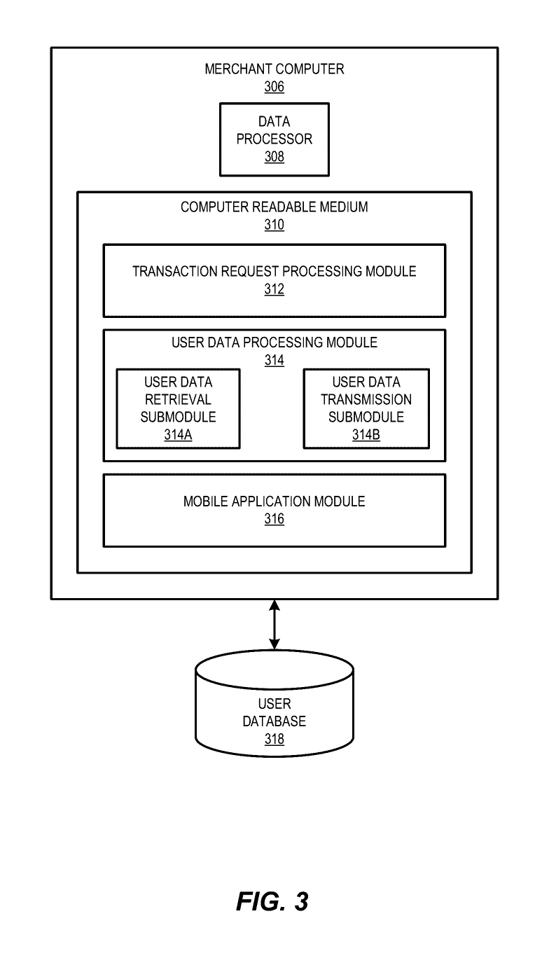

Merchant computer 106 may also sell goods and/or services via a website or mobile application, and may accept payments over the Internet. In some embodiments, merchant computer 106 may host a mobile application. In some cases, merchant computer 106 may include or be in communication with merchant databases 118, which may comprise one or more databases. FIG. 3 describes various components of an exemplary merchant computer in further detail.

Acquirer computer 108 is typically a system for an entity (e.g. a bank) that has a business relationship with a particular merchant, a wallet provider, or other entity. Acquirer computer 108 may be communicatively coupled to merchant computer 106 and payment processing network 110 and may issue and manage an account of a merchant.

Payment processing network 110 may include data processing subsystems, networks, and operations used to support and deliver authorization services, and clearing and settlement services. For example, payment processing network 110 may comprise a server computer, coupled to a network interface, and a database of information. Payment processing network 110 may include wired or wireless network, including the internet. An example of payment processing network 110 includes VisaNet®, operated by Visa®. Payment processing networks such as VisaNet™ are able to process credit card transactions, debit card transactions, and other types of commercial transactions. VisaNet™, in particular, includes a VIP system (Visa Integrated Payments system), which processes authorization requests and a Base II system which performs clearing and settlement services.

Digital wallet server 112 may provide some or all of the functionality associated with conducting transactions using an electronic wallet. Digital wallet server 112 may be accessible to user 102 by communication networks 116 and may also be in operational communication with merchant computer 106 and/or payment processing network 110. In some embodiments, digital wallet server 112 may be a part of payment processing network 110. In some embodiments, digital wallet server 112 may include or be in communication with digital wallet databases 120, which may comprise one or more databases.

Digital wallet server 112 may be programmed or configured to provide some or all of the functionality associated with conducting transactions using an electronic wallet, including maintaining an association between a digital wallet of user 102 and one or more payment accounts (e.g., a bank account or credit card account) in digital wallet databases 120. To provide digital wallet services, digital wallet server 112 may further provide a web interface (e.g. through one or more web pages) to receive and transmit request for payment services and/or provide an application program interface (API) at mobile device 104 to provide the web service.

Issuer computer 114 may be operated by an account issuer. Issuer computer 114 may also be known as an authorization computer. Typically, the issuer is a business entity (e.g. a bank) which maintains financial accounts (e.g., credit card account, checking account, savings account, merchant account, prepaid account, etc.) for the consumer and often issues a payment device, such as a credit, debit, prepaid, or other card, to the cardholder. Some entities can perform both issuer computer and acquirer computer functions. Embodiments of the invention encompass such single entity issuer-acquirers. Issuer computer 114 may be an example of an authorization computer and may determine whether a transaction can be authorized.

The computing devices described herein (e.g., mobile device 104, merchant computer 106, acquirer computer 108, payment processing network 110, digital wallet server 112, and issuer computer 114, etc.) may each include a processor and a computer readable medium coupled to the processor, the computer readable medium comprising code, executable by the processor. The computing devices may also each include an external communication interface for communicating with each other and other entities.

FIG. 2 depicts a block diagram of an exemplary mobile device 204. FIG. 2 shows a number of components, and mobile device 204 according to embodiments of the invention may comprise any suitable combination or subset of such components.

Mobile device 204 may include a processor 204A (e.g., a microprocessor) for processing functions of mobile device 204. One exemplary function enabled by processor 204A includes processing functions of display 204H to allow a consumer to see information (e.g., interfaces, contact information, messages, etc.). Processor 204A may include hardware within mobile device 204 that can carry out instructions embodied as code in a computer-readable medium.

An exemplary processor may be a central processing unit (CPU). As used herein, a processor can include a single-core processor, a plurality of single-core processors, a multi-core processor, a plurality of multi-core processors, or any other suitable combination of hardware configured to perform arithmetical, logical, and/or input/output operations of a computing device.

Mobile device 204 may comprise a secure element 204B. Secure element 204B may be a secure memory on mobile device 204 such that the data contained on secure element 204B cannot easily be hacked, cracked, or obtained by an unauthorized entity. Secure element 204B may be utilized by mobile device 204 to host and store data and applications that may require a high degree of security. Secure element 204B may be provided to mobile device 204 by a secure element issuer. Secure element 204B may be either embedded in the handset of mobile device 204 or in a subscriber identity module (SIM) card that may be removable from mobile device 204. Secure element 204B can also be included in an add-on device such as a micro-Secure Digital (micro-SD) card or other portable storage device.

Secure element 204B may store any suitable sensitive information. For example, secure element 204B may store financial information, bank account information, account (e.g., credit, debit, prepaid) number information, payment tokens associated with such account number information, account balance information, expiration dates, and verification values (e.g., CVVs, dCVVs, etc.). Other information that may be stored in secure element 204B may include consumer information or user data (e.g., name, date of birth, contact information, etc.). In other embodiments, some, none, or all of the foregoing information may be stored in memory element 204C or may be stored at a remote server computer (e.g., in the cloud).

Mobile device 204 may comprise a memory element 204C (e.g., computer readable medium). Memory element 204C may be present within a body of mobile device 204 or may be detachable from the body of mobile device 204. The body of mobile device 204 may be in the form of a plastic substrate, housing, or other structure. Memory element 204C may store data (e.g., applications, etc.) and may be in any suitable form (e.g., a magnetic stripe, a memory chip, etc).

Memory element 204C may comprise mobile applications 204D. Mobile applications 204D may be computer code or other data stored on a computer readable medium (e.g., memory element 204C or secure element 204B) that may be executable by processor 204A to complete a task (e.g., provide a service). Mobile applications 204D may be applications that operate on mobile device 204 and that may provide a user interface for user interaction (e.g., to enter and view information).

In some cases, mobile applications 204D may include one or more payment applications. Mobile applications 204D may communicate with a wallet provider server computer (e.g., digital wallet server) to retrieve and return information during processing of any of a number of services offered to the user via mobile device 204 (e.g., provisioning accounts to a wallet application stored on mobile device 204). In other embodiments, mobile applications 240D may include one or more non-payment applications with which the user may have enrolled accounts.

Memory element 204C may also comprise a verification module 204E. Verification module 204E may be computer code or other data stored on a computer readable medium (e.g., memory element 204C or secure element 204B) that enables determining whether information received from biometric reader 204L is valid. For example, verification module 204E, in conjunction with processor 204A, may compare a biometric identifier read by biometric reader 204L and an enrolled biometric identifier stored by mobile device 204. If the two identifiers match, verification module 204E, in conjunction with processor 204A, may verify that the received biometric identifier is valid and may authenticate the user that entered the biometric identifier. In some embodiments, verification module 204E, in conjunction with processor 204A, may determine how well two identifiers match (e.g., 90% match) and utilize the determination to calculate a risk associated with authorizing the biometric identifier.

Mobile device 204 may further include a contactless element 204F, which may typically be implemented in the form of a semiconductor chip (or other data storage element) with an associated wireless transfer (e.g., data transmission) element, such as an antenna. Contactless element 204F may be associated with (e.g., embedded within) mobile device 204. Data or control instructions transmitted via a cellular network may be applied to contactless element 204F by means of a contactless element interface (not shown). In some cases, the contactless element interface may function to permit the exchange of data and/or control instructions between the mobile device circuitry (and hence the cellular network) and an optional contactless element 204F.

Contactless element 204F may be capable of transferring and receiving data using a near-field communications (NFC) capability (or NFC medium) typically in accordance with a standardized protocol or data transfer mechanism (e.g., ISO 14443/NFC). Mobile device 204 may support contactless transactions using the EMV contactless communication protocol (EMV-CCP), which is based on ISO 14443, in order to interact with merchant access devices. This capability may typically be met by implementing NFC. The NFC capability of mobile device 204 may be enabled by an embedded NFC chip or by the addition of an external memory card or accessory that contains the NFC chip. NFC capability is a short-range communications capability, such as RFID, Bluetooth®, infra-red, or other data transfer capability that can be used to exchange data between the mobile device 204 and an interrogation device. Thus, mobile device 204 may be capable of communicating and transferring data and/or control instructions via both cellular network and near-field communications capability.

Mobile device 204 may further include an antenna 204G for wireless data transfer (e.g., data transmission). Antenna 204G may be utilized by mobile device 204 to send and receive wireless communications. Antenna 204G may assist in connectivity to the Internet or other communications networks and enable data transfer functions. Antenna 204G may enable SMS, USSD, as well as other types of cellular communications, such as voice call and data communications.

Mobile device 204 may include a display 204H that may show information to a user. Display 204H may be any suitable screen that enables touch functionality. In some embodiments, display 204H of mobile device 204 may display a user interface (e.g., of a mobile application or website) that may allow the user to select and interact with objects presented on display 204H. The objects may include, but may not be limited to, menus, text fields, icons, and keys/inputs on a virtual keyboard. In some embodiments, display 204H may enable a user to manually provide information to mobile device 204 by directly touching display 204H with their finger or suitable touch screen stylus pen.

Mobile device 204 may include a speaker 204I, which may be any suitable device that can produce sound in response to an electrical audio signal. Speaker 204I may play recorded sounds, as well as prerecorded messages to communicate with a user. In some cases, the user may be able to receive instructions by voice communications played by speaker 204I to which the user may respond (e.g., by returning voice command, activating input elements, etc.).

Mobile device 204 may include a microphone 204J, which may be any suitable device that can convert sound to an electrical signal. Microphone 204J may be utilized to capture one or more voice segments from a user. For example, microphone 204J may allow the user to transmit his or her voice to mobile device 204. In some embodiments, the user may utilize voice commands detected by microphone 204J to provide instructions to mobile device 204. In some cases, the user may provide voice commands detected by microphone 204J to navigate through mobile applications 204D.

Mobile device 204 may further include input elements 204K to allow a consumer to input information into mobile device 204. Example input elements 204K include hardware and software buttons, audio detection devices (e.g., microphone 204J), biometric readers, touch screens, and the like. A user may activate one or more of input elements 204K, which may pass user information to mobile device 204. In some cases, one or more of input elements 204K may be utilized to navigate through various screens of mobile applications 204D.

Input elements 204K may include a biometric reader 204L that can read biometric information from a user. Biometric reader 204L may be any suitable combination of hardware and software that can convert biometric information received from the user into biometric identifiers unique to the user. For example, biometric reader 204L may be capable of processing fingerprints, retinal scans, and voiceprints and generating biometric identifiers from the processed information. Biometric reader 204L may transmit biometric identifiers and other information to verification module 204E to verify the user.

In some embodiments, where mobile device 204 is a phone or other similar computing device, mobile device 204 may include a browser stored in the memory element 204C and may be configured to retrieve, present, and send data across a communications network (e.g., the Internet). In such embodiments, mobile device 204 may be configured to send data as part of a transaction. In some embodiments, mobile device 204 may provide the data upon request from another entity.

FIG. 3 shows a block diagram of some components that may be in an exemplary merchant computer 306 according to embodiments of the invention. Merchant computer 306 comprises a data processor 308 and a computer readable medium 310. Merchant computer 306 may be in communication with one or more databases, such as a user database 318.

The computer readable medium 310 may comprise a number of software modules including a transaction request processing module 312, a user data processing module 314 comprising a user data retrieval submodule 314A and a user data transmission submodule 314B, and a mobile application module 316. Each module in merchant computer 306 may comprise one or submodules, where each submodule may comprise one or more functions implemented by code, executable by data processor 308. Each module may include code for providing information to another entity, such as other modules in merchant computer 306, as appropriate.

Other modules and submodules may also reside on the computer readable medium 310. Examples of additional modules may include modules for financial processing, data extraction (e.g., for retrieving data from external data sources such as databases), and message modification.

Transaction request processing module 312 may comprise code to enable receiving, processing, and sending transaction messages. Transaction request processing module 312, in conjunction with data processor 308, may detect when a user utilizing a mobile application associated with merchant computer 306 initiates a transaction. For example, the user may navigate to a payment page and indicate (e.g., by a button press) that they would like to conduct a transaction using a digital wallet service, which may send a transaction request to merchant computer 306. Upon receiving the transaction request, transaction request processing module 312, in conjunction with data processor 308, may determine and then notify user data processing module 314 whether the user has previously utilized the digital wallet service with the mobile application. In some embodiments, transaction request processing module 312, in conjunction with data processor 308, may extract other information (e.g., device identifiers) from the transaction request and communicate the information to user data processing module 314.

User data processing module 314 may comprise code to enable the handling of user information. User data processing module 314, in conjunction with data processor 308, may receive a notification from transaction request processing module 312 as to whether a user has previously utilized a digital wallet service with a mobile application associated with merchant computer 306. If it is not the first time the user has utilized the digital wallet service with the mobile application, mobile application module 316 may be notified. If it is the first time the user has utilized the digital wallet service with the mobile application, user data retrieval submodule 314A and user data transmission submodule 314B may be notified.

User data retrieval submodule 314A may comprise code to enable merchant computer 316 to obtain user information. User data retrieval submodule 314A, in conjunction with data processor 308, may access user database 318 and then determine user data related to a user conducting a transaction stored in the user database 318. The user data may have been previously registered by the user when creating an account for a mobile application associated with merchant computer 306. The user data may include alias identifiers (e.g., email address, phone number, etc.) of the user. In some embodiments, the user data may include device identifiers (e.g., cookies) associated with a mobile device utilized by the user. User data retrieval submodule 314A, in conjunction with data processor 308, may communicate the user data to user data transmission submodule 314B.

User data transmission submodule 314B may comprise code to enable sending of retrieved user data. User data transmission submodule 314B, in conjunction with data processor 308, may communicate the user data received from user data retrieval submodule 314A to a digital wallet server, which may provide digital wallet services to a user conducting a transaction with merchant computer 306. In some embodiments, user data transmission submodule 314B, in conjunction with data processor 308, may generate hashes of the retrieved user data and send the hashed versions of user data to the digital wallet server instead of the user data.

Mobile application module 316 may comprise code to enable any functionality of a mobile application hosted by merchant computer 306. Mobile application module 316, in conjunction with data processor 308, may enable communication (e.g., receiving and sending notifications) with a mobile application hosted by another entity (e.g., issuer) that may reside on a mobile device. Mobile application module 316, in conjunction with data processor 308, may also enable the mobile application of merchant computer 306 to send a request for verification of a user to a mobile application hosted by another entity (e.g., issuer) residing on a mobile device. Additionally, mobile application module 316, in conjunction with data processor 308, may enable typical payment processing, such as receiving and processing a payload, generating and sending an authorization request message, and receiving an authorization response message.

User database 318 may store any information related to user registration. For example, user database 318 may comprise registered user data, including any suitable alias identifiers and contact information, associated with each user conducting a transaction with merchant computer 306. User database 318 may also include transaction details associated with transactions previously conducted by the user. Additionally, user database 318 may comprise any mobile application user preferences associated with each user. In some embodiments, information in user database 318 may be stored in any suitable storage mechanisms, such as one or more lookup tables.

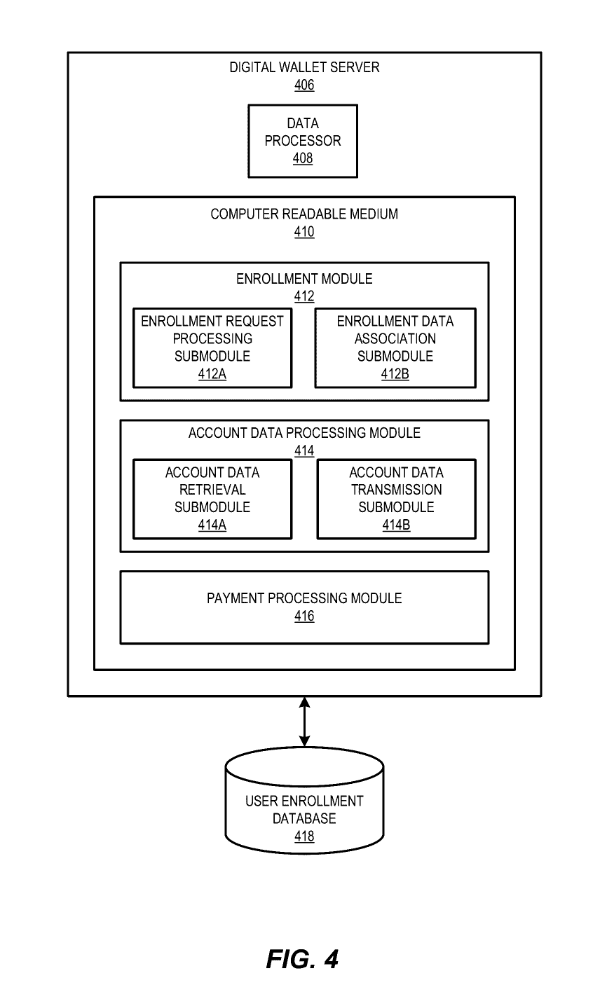

FIG. 4 shows a block diagram of some components that may be in an exemplary digital wallet server 406 according to embodiments of the invention. Digital wallet server 406 comprises a data processor 408 and a computer readable medium 410. Digital wallet server 406 may be in communication with one or more databases, such as a user enrollment database 418.

The computer readable medium 410 may comprise a number of software modules including an enrollment module 412 comprising an enrollment request processing submodule 412A and enrollment data association submodule 412B, an account data processing module 414 comprising an account data retrieval submodule 414A and account data transmission submodule 414B, and payment processing module 416. Each module in digital wallet server 406 may comprise one or submodules, where each submodule may comprise one or more functions implemented by code, executable by data processor 408. Each module may include code for providing information to another entity, such as other modules in digital wallet server 406, as appropriate.

Other modules and submodules may also reside on the computer readable medium 410. Examples of additional modules may include modules for financial processing, data extraction (e.g., for retrieving data from external data sources such as databases), and message modification.

Enrollment module 412 may comprise code to enable storing and retrieving of user registration information. Registration information may also be referred to by any suitable name, such as registration data, enrollment information, and enrollment data. Enrollment module 412, in conjunction with the data processor 408, may also manage integrity of enrollment information and update any newly received registration information as appropriate. Enrollment module 412 may comprise enrollment request processing submodule 412A and enrollment data association submodule 412B.

Enrollment request processing submodule 412A may comprise code to enable receiving and processing a request to register a user with digital wallet server 406. Enrollment request processing submodule 412A, in conjunction with data processor 408, may receive an enrollment request and extract enrollment included in the enrollment request. The enrollment request may be received from a mobile device associated with the user over a suitable communications network. Enrollment request processing submodule 412A, in conjunction with data processor 408, may notify enrollment module 412 to generate or update a record of the user at user enrollment database 418, wherein the record may store enrollment information associated with the user.

Enrollment data association submodule 412B may comprise code to enable storing enrollment data in association with other information related to a user. Enrollment data association submodule 412B, in conjunction with data processor 408, may request an authorization computer (e.g., issuer computer) for payment account data of a user identified based on enrollment data processed by enrollment request processing submodule 412A. The payment account data may include information related to one or more payment accounts of the user. Enrollment data association submodule 412B, in conjunction with data processor 408, may store the payment account data in association with the enrollment data of the user. In some embodiments, certain alias identifiers (e.g., email address) from the enrollment data may be mapped to each payment account from the payment account data. In some embodiments, some or all of the received enrollment information and payment account data, as well as a mapping of enrollment information and payment account data may be stored at user enrollment database 418.

Account data processing module 414 may comprise code to enable handling of information related to payment accounts of a user. Account data may also be referred by any suitable name, such as account information, payment account data, or payment account information. Account data processing module 414 may comprise account data retrieval submodule 414A and account data transmission submodule 414B.

Account data retrieval submodule 414A may comprise code to enable retrieving stored account information associated with a user when the user conducts a transaction. If any information associated with the user is stored at user enrollment database 418, account data processing module 414, in conjunction with data processor 408, may query user enrollment database 418 with an identifier (e.g., alias identifier) of the user (e.g., email address). The identifier may be part of user data received from a merchant computer. Account data retrieval submodule 414A, in conjunction with data processor 408, may then obtain payment account data stored in association with enrollment data of the user. Account data may be determined by digital wallet server 406 without directly communicating with the user during the transaction.

In some embodiments, the user data received from a merchant computer may be hashed. Account data retrieval submodule 414A, in conjunction with data processor 408, may utilize hash keys received from the merchant computer during a previous enrollment process to determine hashed version of enrollment data stored by digital wallet server 406. Account data retrieval submodule 414A, in conjunction with data processor 408, may then compare the hashed user data and hashed enrollment data, determine hashed user data and hashed enrollment data that match, and obtain payment account data associated with the hashed enrollment data.

Account data transmission submodule 414B may comprise code to enable presenting account data to other entities. Account data transmission submodule 414B, in conjunction with data processor 408, may determine one or more payment accounts available to a user based on payment account data retrieved by account data retrieval submodule 414A and obtain account identifiers associated with each of the one or more payment accounts. The account identifiers may be any suitable identifiers that uniquely identify each payment account to the user. For example, each account identifier may be virtual card art, an account number, or a partial account number associated with a payment account.

Account data transmission submodule 414B, in conjunction with data processor 408, may send the account identifiers to a mobile application operated by the user (e.g., application associated with a merchant computer). In some embodiments, account data transmission submodule 414B, in conjunction with data processor 408, may embed the account identifiers in a software button to be presented by the mobile application being utilized by a user. The software button may be configured such that after the user clicks the button, the account identifiers may be displayed to the user. The mobile application may present the account identifiers in any suitable manner (e.g., by a list, group of tiles, etc.).

Payment processing module 416 may enable typical payment transaction processing. Payment processing module 416 may enable receiving, processing, and routing authorization request messages and authorization response messages. In some cases, payment processing module 416 may store any transaction data retrieved during transaction processing in user enrollment database 418.

User enrollment database 418 may store any information related to user registration. For example, enrollment database 418 may comprise enrollment data received from a user, including any suitable contact information and identifiers. The enrollment data may be stored in association with payment account data of each user in user enrollment database 418. Additionally, user enrollment database 418 may comprise information indicating merchant applications that the user has previously conducted a transaction with utilizing a digital wallet associated with digital wallet server 406. In some embodiments, information in user enrollment database 418 may be stored in any suitable storage mechanisms, such as one or more lookup tables. Further, the data in the user enrollment database 418 could be hashed or encrypted in some embodiments of the invention.

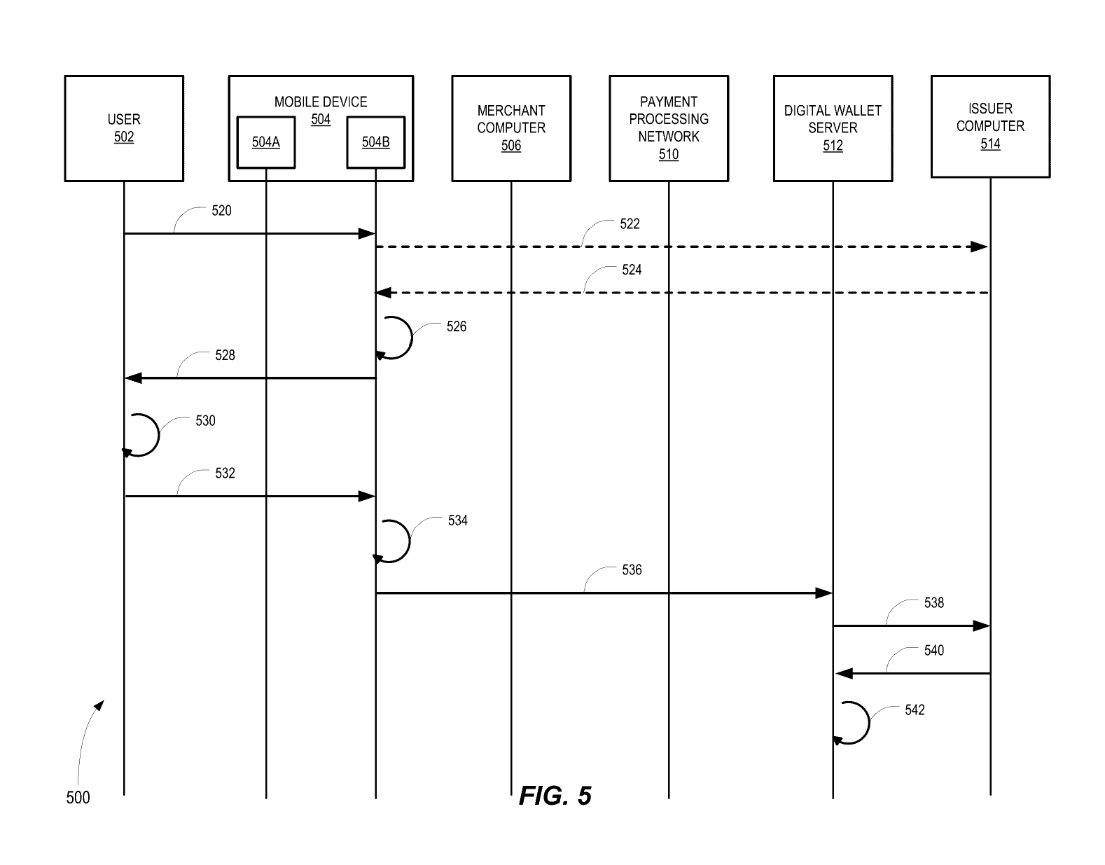

FIG. 5 shows an exemplary flow diagram 500 of an enrollment process according to embodiments of the invention. FIG. 5 includes a user 502, a mobile device 504 running a first mobile application 504A and a second mobile application 504B, a merchant computer 506, a payment processing network 510, a digital wallet server 512, and an issuer computer 514. In some embodiments, the first mobile application 504A may be a merchant application and the second mobile application 504B may be an issuer application. Entities included in FIG. 5 may have similar or different characteristics to entities in FIG. 1 and other figures described herein.

At step 520, user 502 may launch the second mobile application 504B on their mobile device 504. In some embodiments, the second mobile application 504B may be an issuer application that hosts one or more payment accounts user 502. The following steps 522 and 524 are shown in dotted lines to indicate that they are optional steps.

At step 522, the second mobile application 504B may communicate with issuer computer 514 to request any information that may be utilized by the second mobile application 504B during it use by user 502. In some embodiments, the request may be for information related to an account that user 502 has with mobile application 504B. For example, issuer computer 514 may have stored relevant information related to user 502 that may be displayed by mobile device 504 on a user interface. In some cases, second mobile application 504B may request a name, contact information, payment account information, and application settings related to user 502.

Upon receiving the request for information from the second mobile application 504B, issuer computer 514 may detect that the request is from user 502 and may retrieve information indicated in the request. In some cases, issuer computer 514 may retrieve the requested information from one or more databases.

At step 524, issuer computer 514 may send mobile device 504 the requested information that may be utilized by the second mobile application 504B. Issuer computer 514 may send the information to mobile device 504 over any suitable communications network.

In some embodiments, steps 522 and 524 may not be conducted every time user 502 launches mobile application 504B. For example, information utilized by the second mobile application 504B may be stored locally at mobile device 504. In this case, mobile device 504 may retrieve relevant information from its local storage after user 502 launches mobile application 504B.

At step 526, mobile device 504 may display a user interface for mobile application 504B. In some embodiments, the user interface may be customized based on application settings set by user 502. The second mobile application 504B may display information related to one or more payment accounts of user 502 that are issued by issuer computer 514.

At step 528, the second mobile application 504B may prompt user 502 to enroll one or more payment accounts associated with issuer 514 with digital wallet server 512. The second mobile application 504B may prompt user 502 in any suitable manner (e.g., send an alert notification, display a pop-up message, etc.).

At step 530, user 502 may choose to enroll one or more payment accounts with digital wallet server 512. User 502 may acknowledge that they would like to conduct an enrollment process by providing input to the user interface of second mobile application 504B (e.g., clicking a pop-up message, etc.).

At step 532, user 502 may provide enrollment data to the mobile application 404B. In some embodiments, the enrollment data may be digital wallet enrollment data. For example, user 502 may enter alias identifiers (e.g., email address, phone number, etc.) associated with one or more payment accounts that user 502 would like to enroll. Each payment account that user 502 enrolls may be associated with at least some enrollment data. In some embodiments, user 502 may forgo the need to enter payment account information or payment account identifiers during the enrollment process.

In some embodiments, the second mobile application 504B may request user 502 to provide a biometric identifier for verification. The biometric identifier (e.g., fingerprint, retinal scan, voiceprint, etc.) may be any suitable identifier that can uniquely identify user 502. User 502 may provide the biometric identifier to any suitable biometric reader on mobile device 504.

At step 534, the second mobile application 504B may verify the biometric identifier received from user 502. The second mobile application 504B may compare the received biometric identifier with a biometric identifier previously enrolled by user 502. If the biometric identifiers match, the second mobile application 504B may verify that the received biometric identifier is valid and enable transmission of the enrollment data to digital wallet server 512. In some embodiments, the second mobile application 504B may enable transmission of the enrollment data if the received biometric identifier and enrolled biometric identifier match to a certain threshold (e.g., at least 90% match).

In some embodiments, the biometric identifier received from user 502 may be verified by an entity other than mobile device 504. For example, mobile device 504 may send the biometric identifier to issuer computer 514, which may verify the biometric identifier against a biometric identifier of user 502 previously stored by issuer computer 514.

At step 536, the second mobile application 504B may send the enrollment data to digital wallet server 512 with a request for generation of a record at digital wallet server 512 associated with user 502. In some embodiments, the request may be for generation of an account at digital wallet server 512 associated with user 502.

At step 538, digital wallet server 512 may store the received enrollment data and send a request to issuer computer 514 for payment account information related to the payment accounts that user 502 is enrolling. Digital wallet server 512 may request payment account information that may be typically utilized for an online transaction. For example, the payment account information may include a PAN, CVV, expiration date, or any other suitable information for each payment account.

At step 540, issuer computer 514 may receive the request and send the relevant payment account information to digital wallet server 512. In some embodiments, issuer 514 may retrieve the payment account information from one or more databases. In some cases, the payment account information may be encrypted to increase security.

While a verification process utilizing a biometric identifier is described above, embodiments are not so limited as user 502 may be verified in other suitable methods. For example, user 502 may directly contact the issuer associated with issuer computer 514 (e.g., by a phone call) and request that the relevant payment account data be sent to digital wallet server. The issuer may verify user 502 by a series of steps, which may include requesting user 502 for personal identification information, asking security questions, and checking whether the received information is valid. If user 502 may be verified, then issuer computer 514 may send the payment account data to digital wallet server 512.

At step 542, digital wallet server 512 may store the payment account information received from issuer computer 514 in association with the enrollment data received from mobile device 504. For example, digital wallet server 512 may store the payment account information and digital wallet enrollment data in a record corresponding to user 502 in a user enrollment database.

In some embodiments, user 502 may wish to enroll payment accounts associated with multiple issuers. User 502 may repeat the steps described in FIG. 5 for each issuer for which user 502 has registered payment accounts.

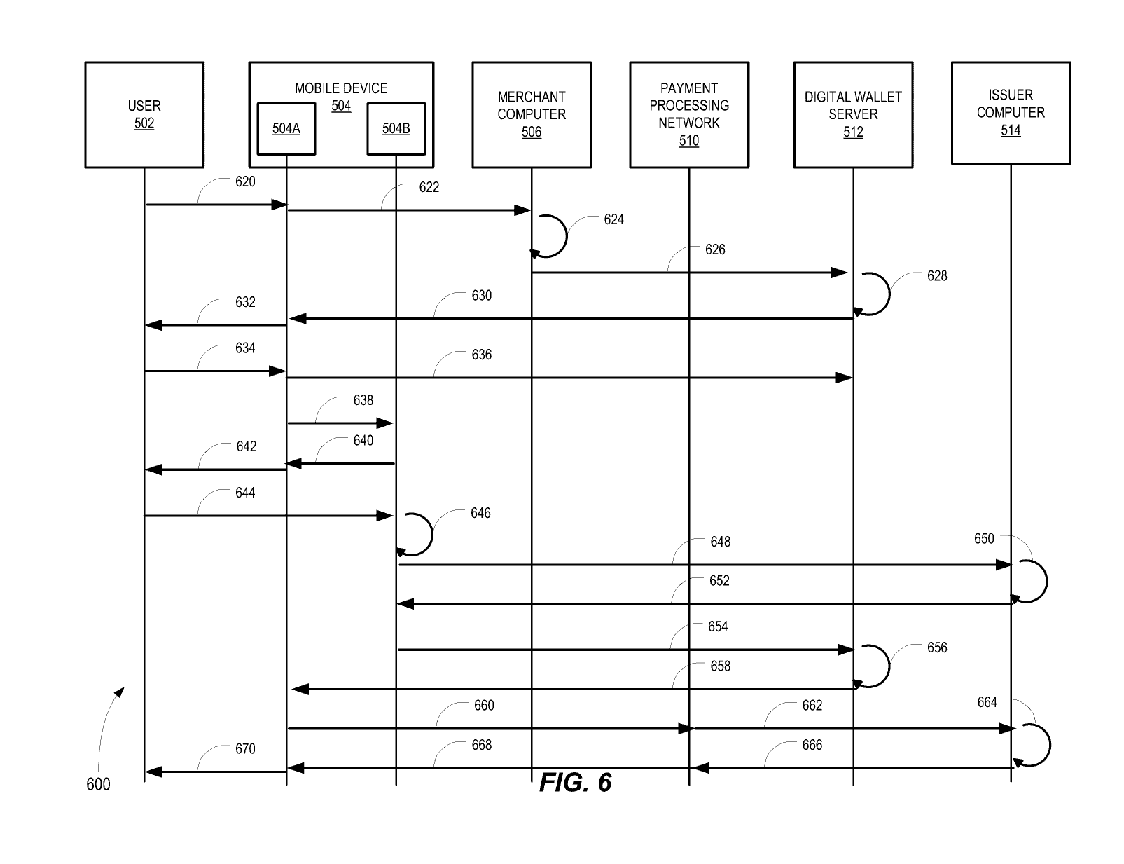

FIG. 6 shows an exemplary flow diagram 600 of a transaction according to embodiments of the invention. FIG. 6 may describe the first time that user 502 has requested to utilize a digital wallet stored at digital wallet server 512 for a transaction with mobile application 504A.

FIG. 6 includes user 502, a mobile device 504 running a first mobile application 504A and a second mobile application 504B, merchant computer 506, payment processing network 510, digital wallet server 512, and issuer computer 514. In some embodiments, the first mobile application 504A may be a merchant application and the second mobile application 504B may be an issuer application. Entities included in FIG. 6 may have similar or different characteristics to entities in FIG. 1 and other figures described herein.

At step 620, user 502 may launch the first mobile application 504A on mobile device 504 and initiate a transaction. In some embodiments, the first mobile application 504A may be a merchant application hosted by merchant computer 506. User 502 may have a mobile application account associated with the first mobile application 504A. Mobile device 504 may contact the merchant computer 506 to conduct a transaction. In some cases, user 502 may initiate a transaction indicating an intention to utilize a digital wallet for the transaction. User 502 may initiate the transaction in any suitable manner. For example, user 502 may choose a product to purchase and navigate to a payment page on mobile application 504A.

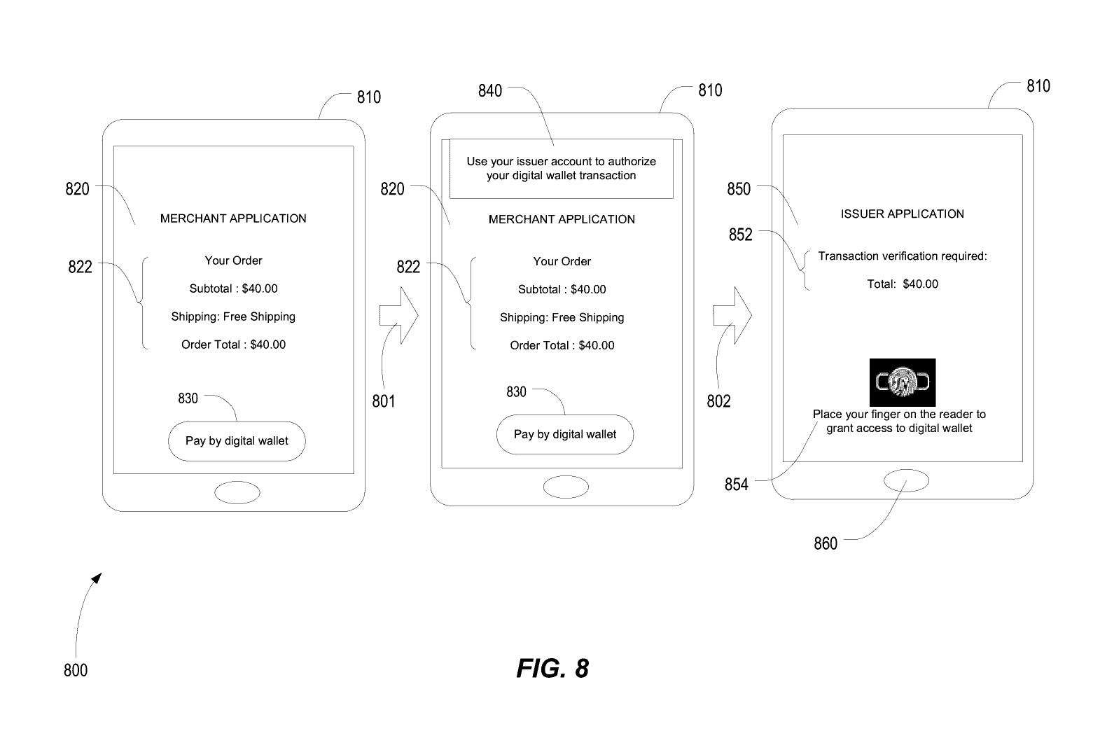

At step 622, merchant computer 506 may receive the indication from mobile application 504A to communicate with digital wallet server 512 for the transaction. User 502 may indicate to the first mobile application 504A to utilize a digital wallet for the transaction in any suitable manner. For example, user 502 may click a software button on the payment page, which triggers communication between mobile device 504 and digital wallet server 512 (See 830 in FIG. 8).

At step 624, merchant computer 506 may obtain user data associated with user 502. The user data may be information previously stored by merchant computer 506. For example, the user data may be information enrolled by user 502 when creating a mobile application account with mobile application 504A. In some embodiments, merchant computer 506 may retrieve alias identifiers (e.g., email address, phone number, etc.) associated with user 502, as well as device identifiers (e.g., cookies, etc.) associated with mobile device 504. The alias identifiers may be any suitable identifiers that can uniquely identify user 502.

At step 626, merchant computer 506 may send the retrieved user data to digital wallet server 512. In some embodiments, merchant computer 506 may hash the user data and send the hashed versions of the user data to digital wallet server 512.

At step 628, digital wallet server 512 may determine payment account data associated with user 502 based on the user data received from merchant computer 506. For example, digital wallet server 512 may compare the user data to enrollment data stored at digital wallet server 512, determine enrollment data that matches the user data, and access account data stored in association with the matching enrollment data. The account data may include information corresponding to one or more payment accounts.

For example, the user data may include an alias identifier (e.g., email address) of user 502. Digital wallet server 512 may include the received alias identifier in a query to the database that is in communication with digital wallet server 512. This may cause the database to search for the received alias identifier and any account data related to the alias identifier and then pass the account data to digital wallet server 512. In this example, the digital wallet server may only receive an e-mail address of the user, and may identify an account number for the user's credit card using the e-mail address. This can be done automatically, without contacting the user. Thus, in embodiments of the invention, the digital wallet server 512 may receive some information about the user, and may retrieve other information about the user and may return this information to the information requester.

In some cases, the alias identifier may be stored in digital wallet server 512 in association with one or more payment accounts of user 502. Accordingly, the alias identifier may be stored in association with any account data related to the one or more payment accounts (e.g., account number, CVV, account issuer, etc.). Some or all of the account data associated with the alias identifier may be sent to digital wallet server 512.

In another exemplary case, the user data may include hashed user data. For example, the user data may include a hashed alias identifier. Digital wallet server 512 may utilize hash information (e.g., hash keys) received from merchant computer 506 during a previous enrollment process to determine hashed versions of alias identifiers in the enrollment data during the transaction. In some cases, digital wallet server 512 may already have stored hashed versions of the enrollment data after receiving the hash information from merchant computer 506 prior to the transaction. Digital wallet server 512 may then compare the received hashed user data with the hashed versions of the enrollment data. If a match can be found to a hashed version of an alias identifier stored in the enrollment data, digital wallet server 512 may determine account data of user 502 stored in association with the alias identifier of the enrollment data. The benefit of using hashed information is that the underlying information is protected from data security breaches.

After determining the payment account data associated with user 502, digital wallet server 512 may determine one or more account identifiers corresponding to the account data. The account identifiers may be any suitable identifiers that can uniquely identify payment accounts to user 502. For example, the account identifiers may be account numbers, partial payment account numbers (e.g., last four digits), virtual card art, and any other suitable identifiers.

As described above in the enrollment flow diagram of FIG. 5, enrollment data and payment account data related to user 502 may be stored in association at digital wallet server 512 or a database that is in communication with digital wallet server 512. Thus, the payment account data may be determined by digital wallet server 512 during a transaction without prompting user 502 for any account information (e.g., account identifiers, account data, etc.).

This makes the user experience smoother, since user 502 does not have to remember any credentials and spend time entering information during the transaction. Typically, user 502 may have to enter credentials (e.g., username and password) to utilize a digital wallet for a transaction conducted through a mobile application. Instead, as described herein, user 502 may automatically receive multiple account options for accounts, where the accounts may be issued by multiple issuers, to utilize for the transaction without entering any account information. This also results in fewer processing steps and the reduced use of computational resources than conventional systems and methods.

At step 630, digital wallet server 512 may send the account identifiers to mobile application 504A. In some embodiments, the account identifiers may be embedded in a software button sent to the first mobile application 504A. For example, the software button may be configured such that upon user 502 clicking the button, the account identifiers embedded in the button may be presented to user 502. In some embodiments, user data (e.g., email address) associated with the account identifiers may be embedded in the button as well.

At step 632, user 502 may activate the button, which may trigger mobile device 504 to display the account identifiers. The account identifiers may be presented to user 502 by any suitable user interface. For example, the account identifiers may be presented in a list, group of tiles, carousel, or other interface that user 502 may browse through. In some embodiments, the user data (e.g., email address) associated with the account identifiers may be presented to user 502 as well.

At step 634, user 502 may select an account identifier from the account identifiers presented by the first mobile application 504A. User 502 may select the account identifier by any suitable method (e.g., activating software or hardware button, clicking on an account identifier, inputting voice command, etc.).

At step 636, the first mobile application 504A may send the selected account identifier to digital wallet server 512. In some embodiments, user data (e.g., email address) associated with the account identifier may also be sent to digital wallet server 512. The first mobile application 504A may recognize that the selected account identifier is associated with a payment account issued by issuer computer 514. In some cases, the first mobile application 504A may also recognize that the second mobile application 504B is associated with the issuer computer 514.

At step 638, the first mobile application 504A may send a request directly to the second mobile application 504B associated with issuer computer 514 to verify user 502. In some embodiments, the first mobile application 504A may send the request to issuer computer 514, which may forward the request to the second mobile application 504B.

In some embodiments, the second mobile application 504B may have a verification process to verify the first mobile application 504A before allowing communication between the first mobile application 504A and the second mobile application 504B. For example, the first mobile application 504A may include verification information (e.g., device data, digital signature, etc.) in the request to the second mobile application 504B.

At step 640, the second mobile application 504B may send an alert notification to the first mobile application 504A requesting verification of user 502. The alert notification may request that user 502 provide permission to verify their identity through the second mobile application 504B. This may be performed directly on the mobile device 504, or through an intermediate server computer or communication network. User 502 may still have the first mobile application 504A opened on mobile device 504 when the alert notification is received.

At step 642, the alert notification from the second mobile application 504B may be displayed by mobile device 504 (See 840 in FIG. 8). The alert notification may be presented in any suitable form. For example, the alert notification may be a banner notification, push notification, a Short Message Service (SMS) notification, or may use other suitable notification form factor.

At step 644, user 502 may acknowledge the received alert notification, which may trigger the second mobile application 504B to launch on mobile device 504. In some embodiments, user 502 may acknowledge the alert by clicking on the alert notification. In other cases, user 502 may not have to acknowledge the received alert notification in order to trigger the second mobile application 504B to launch, since mobile device 504 may automatically launch the second mobile application 504B.

Upon launching, the second mobile application 504B may present a user interface including a request for a biometric identifier from user 502 (See 850 and 854 in FIG. 8) and user 502 may enter their biometric identifier into mobile device 504. The biometric identifier may be any suitable identifier that uniquely identifies user 502 and may be read by a biometric reader on mobile device 504. For example, user 502 may enter a fingerprint to a fingerprint reader (See 860 in FIG. 8) on mobile device 504.

In some embodiments, the user interface displayed by second mobile application 504B may include transaction details (e.g., transaction amount) related to the transaction being conducted by user 502 (See 852 of FIG. 8). These transaction details may be passed from the first mobile application 504A or merchant computer 406 to the second mobile application 504B prior to launching mobile application 504B. In some cases, the transaction details may be passed directly to the second mobile application 504B or to issuer computer 514, which may forward the transaction details to the second mobile application 504. For example, the first mobile application 504A may pass the transaction details to the second mobile application 540B after communication between the first mobile application 504A and the second mobile application 504B is verified as described in step 638.

In some embodiments, mobile device 504 may store the state of the first mobile application 504A while second mobile application 504B is conducting the verification process. For example, the mobile device 504 may store information related to the last activity that was being conducted on the first mobile application 540A. This information may be stored prior to mobile device 504 switching contexts from the first mobile application 504A to the second mobile application 504B, so that when the verification process is completed in second mobile application 504B, the first mobile application 504A may be launched again in the most recent state utilized by user 502 (e.g., displaying payment page). This provides seamless context switching between mobile applications on mobile device 504.

At step 646, the second mobile application 504B may verify the biometric identifier received from user 502. The second mobile application 504B may compare the received biometric identifier with a biometric identifier previously enrolled by user 502. If the biometric identifiers match, the second mobile application 504B may verify that the received biometric identifier is valid and enable the transaction conducted by user 502 to proceed. In some embodiments, the second mobile application 504B may enable the transaction to proceed if the received biometric identifier and enrolled biometric identifier match to a certain threshold (e.g., at least 90% match). A digital artifact or cryptogram may be produced by the second mobile application 504B as proof of the verification or degree of verification by the second mobile application 504B.

In some embodiments, the biometric identifier received from user 502 may be verified by an entity other than mobile device 504. For example, the second mobile device 504 may send the biometric identifier to issuer computer 514, which may verify the biometric identifier against an enrolled biometric identifier of user 502 previously stored by issuer computer 514.

The embodiment above describes the first mobile application 504A and the second mobile application 504B as both residing on mobile device 504. However, the flow described in FIG. 6 may be conducted even when the first mobile application 504A and the second mobile application 504B reside on two separate devices. For example, the first mobile application 504A may be run on a mobile phone of user 502 and the second mobile application 504B may be run on a laptop computer of user 502. This configuration may enable other types of verification to be conducted by the second mobile application 504B.

In some embodiments, the verification process may utilize a one-time code. After the first mobile application 504A requests that the second mobile application 504B verify user 502, the second mobile application 504B running on the laptop computer may generate and send a one-time code to the mobile application 504A running on the mobile phone by a notification. User 502 may retrieve the one-time code from their mobile phone and then enter the one-time code into their laptop computer running mobile application 504B. The second mobile application 504B may then verify user 502 if the one-time code received by the laptop computer and the originally generated one-time code match. This enables an out-of-band authentication process that can be conducted when user 502 is utilizing multiple devices. The method of verification to be utilized during the transaction may be determined by issuer computer 514 or otherwise by user 502 during enrollment.

At step 648, the second mobile application 504B may send an authentication request to issuer computer 514. In some cases, the authentication request may include an indication that user 502 was verified (e.g., by biometric identifier, one-time code, etc.). In some embodiments, the authentication request may further include device data (e.g., cookies, device types, etc.) or other metadata (e.g., geolocation data, etc.) surrounding mobile device 504 and user 502 that may help issuer computer 514 to conduct a risk analysis.

At step 650, issuer computer 514 may conduct a risk analysis based on information included in the authentication request. In some embodiments, the risk analysis may comprise comparing received information to historical account information associated with user 502. In some implementations, the risk analysis may result in a risk score, which may be compared against threshold level (e.g., low risk, medium risk, high risk, etc.) to determine whether the transaction may be authenticated.

At step 652, after the transaction is authenticated, issuer computer 514 may generate and send an authentication response to the second mobile application 504B indicating approval to pass card credentials for the transaction to the first application 504A. In some embodiments, the authentication response may include a message with a flag indicating the approval.

At step 654, the second mobile application 504B may process the authentication response and notify digital wallet server 512 of the approval to pass account data including card credentials to the first application 504A.

At step 656, digital wallet server 512 may generate a secure cryptogram for the transaction. The cryptogram may be generated in any suitable manner (e.g., using DES, triple DES, AES, etc.) and may be in any suitable form.

At step 658, digital wallet server 512 may send a payload for the transaction to the first mobile application 504A. In some embodiments, the payload may be sent to the merchant computer 506 from digital wallet server 512 or from the first mobile application 504A. The payload may include at least a portion of the account data related to the account identifier selected by user 502, a token, the cryptogram, and any other information that may enable the transaction. For example, in some cases, only an account number from the account data may be included in the payload. In other cases, the account number, CVV, and expiration date for the account data may be included in the payload. Mobile device 504 may launch the first mobile application 504A in its last stored state and enter the information from the payload. In some embodiments, mobile device 504 may display a notification that verification was successful.

At step 660, the first mobile application 504A may initiate the sending of an authorization request message for the transaction to payment processing network 510. In some embodiments, the merchant computer 506 may receive a request to initiate an authorization request message. The authorization request message may be generated by the merchant computer 506 and sent to the payment processing network 510. In some embodiments, the authorization request message may be sent to payment processing network 510 via an acquirer computer (not shown).

At step 662, payment processing network 510 may forward the authorization request message to issuer computer 514. In some embodiments, payment processing network 510 may include further information, such as transaction details associated with the transaction or previous transactions of user 502, in the authorization request message before the message is sent to issuer computer 514.

At step 664, issuer computer 514 may determine whether to authorize the transaction based on information in the received authorization request message. In some embodiments, issuer computer 514 may conduct any suitable risk analysis.

At step 666, issuer computer 514 may generate and send an authorization response message to payment processing network 510. In some cases, the authorization response message may include an authorization result indicating that the transaction was authorized. At a later point in time (e.g., after clearing and settlement), the transaction amount may be debited from the payment account associated with the account identifier selected by user 502 for use in the transaction.

At step 668, payment processing network 510 may return the authorization response message to the merchant computer 506, which may then provide the result to the first mobile application 504A. In some embodiments, the authorization response message may be sent to merchant computer 506 via the acquirer computer and merchant computer 506.

At step 670, the first mobile application 504A may present a transaction confirmation notification to user 502 indicating that completion of the transaction.

At a later point in time, in some embodiments, a clearing and settlement process can occur between the issuer computer 514, the payment processing network 510, and the acquirer computer (not shown).

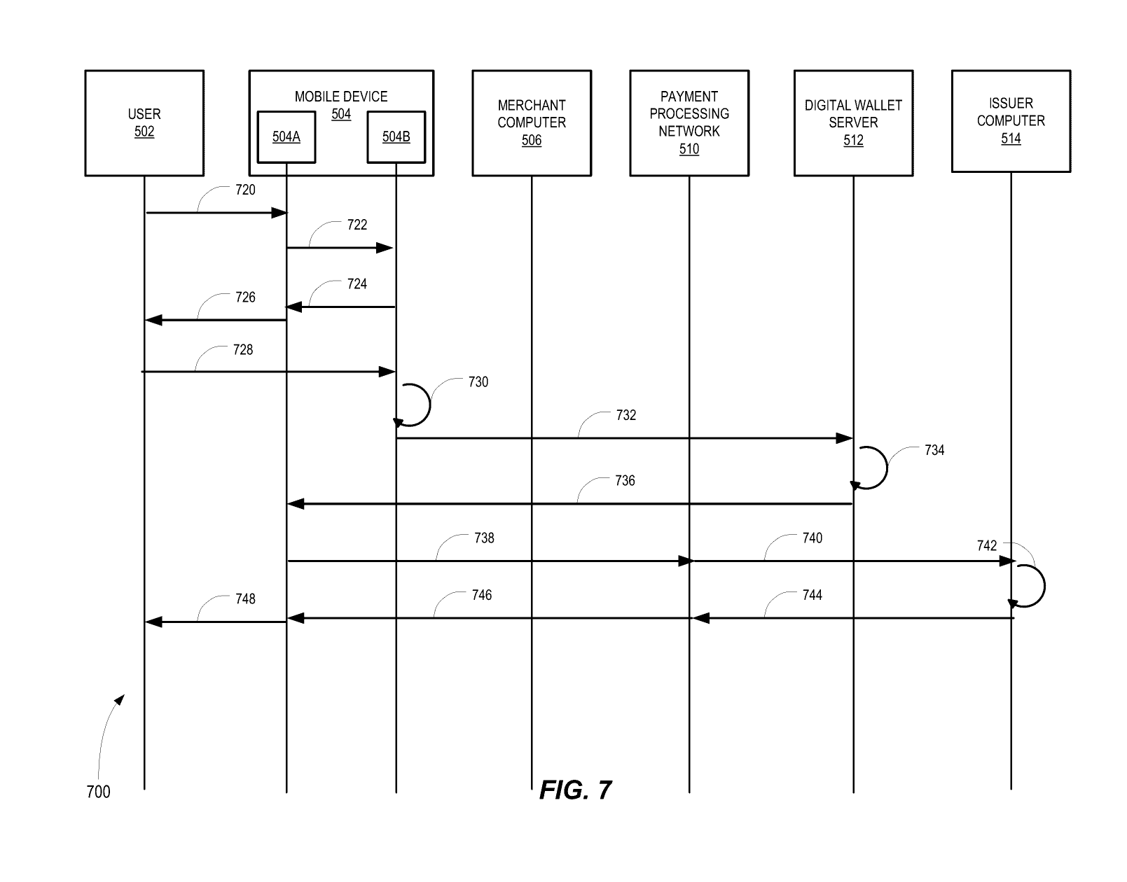

FIG. 7 shows an exemplary flow diagram 700 of a transaction that can be conducted according to embodiments of the invention. FIG. 7 may describe a transaction in which it is not the first time that user 502 has requested to utilize a digital wallet stored at digital wallet server 512 with a first mobile application 504A.

FIG. 7 includes user 502, mobile device 504 running the first mobile application 504A and a second mobile application 504B, merchant computer 506, payment processing network 510, digital wallet server 512, and issuer computer 514. In some embodiments, the first mobile application 504A may be a merchant application and the second mobile application 504B may be an issuer application. Entities included in FIG. 7 may have similar or different characteristics to entities in FIG. 1 and other figures described herein.

At step 720, user 502 may launch the first mobile application 504A to conduct a transaction. Since user 502 has previously utilized the first mobile application 504A with a digital wallet from digital wallet server 512 to conduct a transaction, the first mobile application 504A may already know available user payment accounts of user 502 based on information received from digital wallet server 512. Hence, the first mobile application 504A may simply request that the second mobile application 504B conduct a verification process before utilizing the known payment account data. In some embodiments, the first mobile application 504A may be a merchant application and the second mobile application 504B may be an issuer application.

At step 722, the first mobile application 504A may send a request to second mobile application 504B associated with issuer computer 514 to verify user 502. This can be done directly through the mobile device 504 or through an intermediate server computer. In some embodiments, the first mobile application 504A may send the request to issuer computer 514, which may forward the request to the second mobile application 504B.

In some embodiments, as described in FIG. 6, the second mobile application 504B may have a verification process to verify the first mobile application 504A before allowing communication between the first mobile application 504A and the second mobile application 504B. For example, the first mobile application 504A may include verification information (e.g., device data, digital signature, etc.) in the request to the second mobile application 504B.

At step 724, the second mobile application 504B may send an alert notification to the first mobile application 504A requesting verification. The alert notification may request that user 502 provide permission to verify their identity through the second mobile application 504B. This may be performed directly on the mobile device 504, or through an intermediate server computer or communication network. User 502 may still have mobile application 504A opened on mobile device 504 when the alert notification is received.

At step 726, the alert notification from the second mobile application 504B may be displayed by mobile device 504 (See 840 in FIG. 8). The alert notification may be presented in any suitable form. For example, the alert notification may be a banner notification, push notification, a Short Message Service (SMS) notification, or other suitable notification.

At step 728, user 502 may acknowledge the received alert notification, which may trigger the second mobile application 504B to launch on mobile device 504. In some embodiments, user 502 may acknowledge the alert by clicking on the alert notification. In other cases, user 502 may not have to acknowledge the received alert notification in order to trigger the second mobile application 504B to launch, since mobile device 504 may automatically launch the second mobile application 504B.

Upon launching, the second mobile application 504B may present a user interface including a request for a biometric identifier from user 502 (See 850 and 854 in FIG. 8). The biometric identifier may be any suitable identifier that uniquely identifies user 502 and may be read by a biometric reader on mobile device 504. For example, user 502 may enter a fingerprint to a fingerprint reader (See 860 in FIG. 8) on mobile device 504.

In some embodiments, the user interface displayed by second mobile application 504B may include transaction details (e.g., transaction amount) related to the transaction being conducted by user 502 (See 852 of FIG. 8). These transaction details may be passed from the first mobile application 504A or merchant computer 406 prior to launching mobile application 504B. In some cases, the transaction details may be passed directly to the second mobile application 504B or to issuer computer 514, which may forward the transaction details to the second mobile application 504. For example, the first mobile application 504A may pass the transaction details to the second mobile application 540B after communication between the first mobile application 504A and the second mobile application 504B is verified as described in step 722.

In some embodiments, mobile device 504 may store the state of the first mobile application 504A while second mobile application 504B is conducting the verification process. For example, the mobile device 504 may store information related to the last activity that was being conducted on the first mobile application 540A. This information may be stored prior to mobile device 504 switching contexts from the first mobile application 504A to the second mobile application 504B, so that when the verification process is completed in second mobile application 504B, the first mobile application 504A may be launched again in the most recent state utilized by user 502 (e.g., displaying payment page). This provides seamless context switching between mobile applications on mobile device 504.

At step 730, the second mobile application 504B may verify the biometric identifier received from user 502. The second mobile application 504B may compare the received biometric identifier with a biometric identifier previously enrolled by user 502. If the biometric identifiers match, the second mobile application 504B may verify that the received biometric identifier is valid and enable the transaction conducted by user 502 to proceed. In some embodiments, the second mobile application 504B may enable the transaction to proceed if the received biometric identifier and enrolled biometric identifier match to a certain threshold (e.g., at least 90% match). A digital artifact or cryptogram may be produced by the second mobile application 504B as proof of the verification or degree of verification by the second mobile application 504B

In some embodiments, the biometric identifier received from user 502 may be verified by an entity other than mobile device 504. For example, mobile device 504 may send the biometric identifier to issuer computer 514, which may verify the biometric identifier against an enrolled biometric identifier of user 502 previously stored by issuer computer 514.

The embodiment above describes the first mobile application 504A and the second mobile application 504B as both residing on mobile device 504. However, the flow described in FIG. 7 may be conducted even when the first mobile application 504A and the second mobile application 504B reside on two separate devices. For example, the first mobile application 504A may be run on a mobile phone of user 502 and the second mobile application 504B may be run on a laptop computer of user 502. This configuration may enable other types of verification to be conducted by the second mobile application 504B. For example, a verification process utilizing a one-time code may be conducted as described in step 646 of FIG. 6.

At step 732, the second mobile application 504B may notify digital wallet server 512 of successful verification and may indicate approval to pass account data including card credentials to the first merchant application 504A.

At step 734, digital wallet server 512 may generate a secure cryptogram for the transaction. The cryptogram may be generated in any suitable manner e.g., using DES, triple DES, AES, etc.) and may be in any suitable form.

At step 736, digital wallet server 512 may send a payload for the transaction to first mobile application 504A. In some embodiments, the payload may be sent to the merchant computer 506 from digital wallet server 512 or from the first mobile application 504A. The payload may include at least a portion of the account data related to the account identifier selected by user 502, a token, the cryptogram, and any other information that may enable the transaction. For example, in some cases, only an account number from the account data may be included in the payload. In other cases, the account number, CVV, and expiration date for the account data may be included in the payload. Mobile device 504 may launch the first mobile application 504A in its last stored state and enter the information from the payload. In some embodiments, mobile device 504 may display a notification that verification was successful.

At step 738, the first mobile application 504A may send information to the merchant compute 506 to generate an authorization request message for the transaction. The authorization request message may be sent to payment processing network 510. In some embodiments, the authorization request message may be sent to payment processing network 510 via an acquirer computer.

At step 740, payment processing network 510 may forward the authorization request message to issuer computer 514. In some embodiments, payment processing network 510 may include further information, such as transaction details associated with the transaction or previous transactions of user 502, in the authorization request message before the message is sent to issuer computer 514.

At step 742, issuer computer 514 may determine whether to authorize the transaction based on information in the received authorization request message. In some embodiments, issuer computer 514 may conduct any suitable risk analysis.

At step 744, issuer computer 514 may generate and send an authorization response message to payment processing network 510. In some cases, the authorization response message may include an authorization result indicating that the transaction was authorized. The transaction amount may be credited from the payment account associated with the account identifier selected by user 502 for use in the transaction.

At step 746, payment processing network 510 may return the authorization response message to merchant computer 506, which may inform the first application 504A of the authorization result. In some embodiments, the authorization response message may be sent to merchant computer 506 via the acquirer computer and merchant computer 506.

At step 748, the first mobile application 504A may present a transaction confirmation notification to user 502 indicating that completion of the transaction.

Embodiments of the invention enables a merchant to retrieve known user data from its systems, after the user expresses an intent to use a digital wallet, and then send the user data to a digital wallet server, which can automatically determine multiple user accounts associated with multiple issuers based on the user data without contacting the user for user input. This allows for a smooth user experience as the user does not have to enter any account information during the transaction, even when conducting transactions with merchant applications with which the user has not previously utilized with a digital wallet. Further, the user may have the option to utilize their payment accounts issued by multiple issuers without having to enter multiple user credentials or any account information during the transaction.

While the embodiments described in FIG. 5 though FIG. 7 may be utilized for a financial transaction, embodiments are not so limited. For example, embodiments may be utilized in other non-financial contexts, such as transactions enabling access to resources (e.g., computer files, documents, passwords, etc.) by a user. Also, while specific steps are shown, it is understood that variations of the steps can be present in other embodiments of the invention.

FIG. 8 shows a flow diagram 800 of exemplary user interfaces displayed on a mobile device 810 during a financial transaction according to embodiments of the invention. A user, such as user 102 of FIG. 1, may be operating mobile device 810 to conduct the transaction. In some embodiments, mobile device 810 may have similar features to those described for mobile devices in other figures described herein.

Mobile device 810 may display a user interface 820 of a mobile application associated with a resource providing entity when the user is conducting the transaction. The resource providing entity may be associated with a resource provider server computer. In some embodiments, the resource providing entity may be a merchant associated with a merchant computer and the mobile application may be a merchant application. User interface 820 may include transaction details 822 and an input element 830 enabling use of a digital wallet for the transaction.

Transaction details 822 may be any information regarding the transaction conducted by the user. For example, transaction details 822 may include a transaction amount, items purchased, and a transaction date. In some embodiments, transaction details 822 may include information surrounding the resource providing entity, such as a name, a location, an address, a logo, contact information, and other information related to the associated resource providing entity. Exemplary transaction details 822 in FIG. 8 show a total transaction value of 40 dollars, as well as shipping information related to the transaction.

Input element 830 may enable the user to indicate use of a digital wallet service to conduct the transaction. Input element 830 may be any suitable component that enables detection of user input to mobile device 810. For example, input element 830 may be a software button, a hardware button, or a microphone. In one exemplary case, user interface 820 may include a software button with text, such as “Pay by digital wallet.” Any suitable text may be utilized.

At step 801, if the user determines to utilize a digital wallet to pay for the transaction as described by transaction details 822, the user may click input element 830. This may trigger an alert notification 840 to be sent to the merchant mobile application. Alert notification 840 may be any suitable notification that may be displayed while user interface 820 is still open on mobile device 810. For example, alert notification 840 may be a pop-up message, a banner, or other suitable notification.

Alert notification 840 may be received from a mobile application associated with an authorization computer. In some cases, the authorization computer may be an issuer computer and the mobile application may be an issuer application. Alert notification 840 may indicate to the user that the alert notification 840 was received from the authorization computer by including text, a logo, or other suitable indicator. In one exemplary case, alert notification 840 may be a banner including text, such as “Use your issuer account to authorization your digital wallet transaction.” Any suitable text may be utilized.

At step 802, the user may click alert notification 840 to proceed with authorizing the digital wallet transaction. This may trigger a context switch to the issuer application. For example, mobile device 810 may display a user interface 850 of the issuer application. The merchant application may be closed temporarily and its last state may be saved by mobile device 810.

User interface 850 may display an authorization screen of the issuer application. User interface 850 may include transaction details 852, which may include some or all information included in transaction detail 822 displayed by user interface 820 of the merchant application. In one exemplary case, transaction details 852 may include a total transaction value of 40 dollars. User interface 850 may also include a personal identifier request 854 requesting a personal identifier from the user. The personal identifier may be any suitable identifier that can uniquely identify the user. In some embodiments, the personal identifier may be a biometric identifier (e.g., fingerprint, voiceprint, retinal scan, etc.). In other embodiments, the personal identifier may be any combination of characters and numbers (e.g., passcode, password, etc.). The personal identifier request 854 may be any combination of one or more of drawings, images, text, or audio that may indicate a request for the personal identifier to the user.

The user may enter their personal identifier to a reader 860 on mobile device 810. In some embodiments, reader 860 may be a biometric reader. The biometric reader may be implemented with any combination of hardware and software that may detect and process the personal identifier. In an exemplary case, reader 860 may be a hardware button of mobile device 810 that may serve as a fingerprint reader. The user may place their finger onto reader 860, which may input their personal identifier to mobile device 810, which may transmit the personal identifier to the issuer application. The issuer application may verify the personal identifier and the transaction may be conducted with the digital wallet.

While embodiments above describe the transaction being compatible with a single digital wallet, embodiments are not so limited. For example, there may be multiple payment accounts, which may or may not be hosted by the issuer application of FIG. 8, that may be available for the user to utilize via the digital wallet service. In this case, upon the user activating input element 830, user interface 820 may present the user with the multiple payment account options in any suitable manner. For example, account identifiers corresponding to the multiple payment accounts may be presented in a scrollable list, group of tiles, carousel of items, or any other suitable manner. The user may select an account identifier associated with a payment account to utilize for the transaction. Subsequently, alert notification 840 may be displayed on user interface 820.

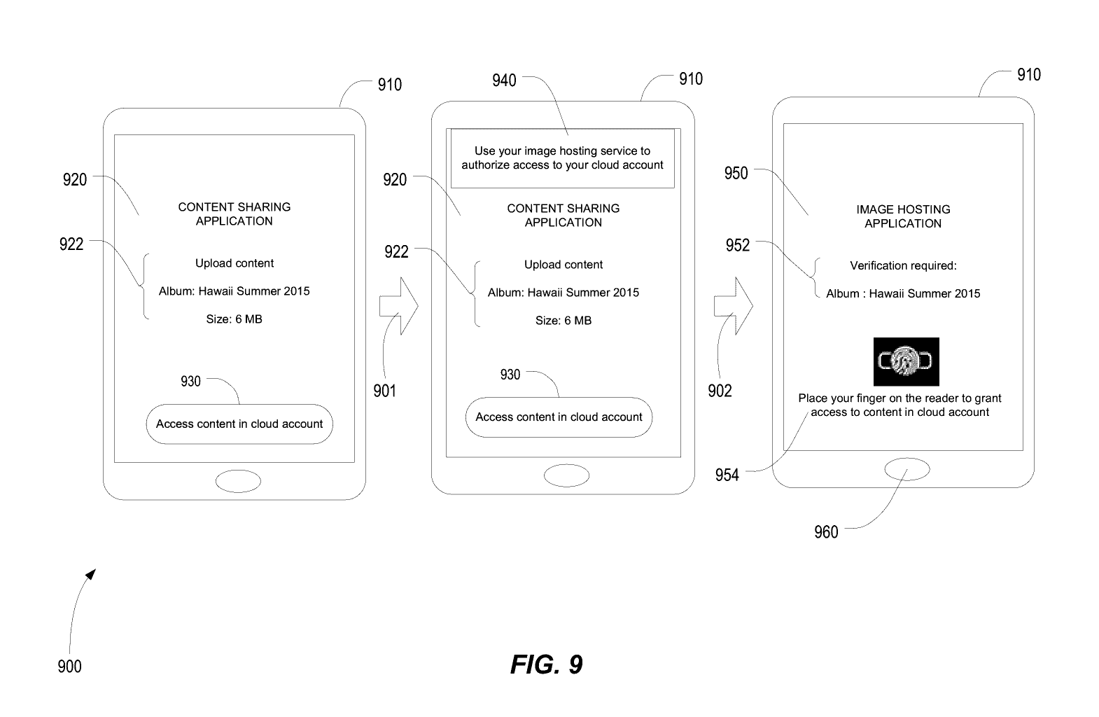

FIG. 9 shows a flow diagram 900 of exemplary user interfaces displayed on a mobile device 910 during a non-financial transaction according to embodiments of the invention. A user, such as user 102 of FIG. 1, may be operating mobile device 910 to conduct the transaction. In some embodiments, mobile device 910 may have similar features to those described for mobile devices in other figures described herein.

Mobile device 910 may display a user interface 920 of a mobile application associated with a content sharing entity when the user is conducting the transaction. The content sharing entity may be associated with a content sharing server computer. In some embodiments, the mobile application may be a content sharing application. User interface 920 may include transaction details 922 and an input element 930 activating access to content in a cloud account.

Transaction details 922 may be any information regarding content being handled by the user. In some embodiments, transaction details 922 may be content details. For example, transaction details 922 may include content name, content type, and content size. In some embodiments, transaction details 922 may include information surrounding the content sharing entity, such as a name, a location, an address, a logo, contact information, and other information related to the associated resource providing entity. Exemplary transaction details 922 in FIG. 9 show a name, “Hawaii Summer 2015,” a type, “Photo Album,” and a size, “6 MB.”

Input element 930 may enable the user to indicate request to access content in a cloud account. Input element 930 may be any suitable component that enables detection of user input to mobile device 910. For example, input element 930 may be a software button, a hardware button, or a microphone. In one exemplary case, user interface 920 may include a software button with text, such as “Access content in cloud account.” Any suitable text may be utilized.

At step 901, if the user determines to access content in the cloud account that is described by content details 922, the user may click input element 930. This may trigger an alert notification 940 to be sent to the content sharing application. Alert notification 940 may be any suitable notification that may be displayed while user interface 920 is still open on mobile device 910. For example, alert notification 940 may be a pop-up message, a banner, or other suitable notification.

Alert notification 940 may be received from a mobile application associated with an authorization computer that holds an account with the user. The account may hold content that is backed up to the cloud account that the user is trying to access. In some embodiments, the authorization computer may be a content provider server computer, such as an image hosting server computer, and the mobile application may be an image hosting application. The image hosting application may host the user's account, which may have content backed up to the cloud account. Alert notification 940 may indicate to the user that the alert notification 940 was received from the image hosting application by including text, a logo, or other suitable indicator. In one exemplary case, alert notification 940 may be a banner including text, such as “User your image hosting service to authorize access to your cloud account.” Any suitable text may be utilized.

At step 902, the user may click alert notification 940 to proceed with authorizing the access to the content in the cloud account. This may trigger a context switch to the image hosting application. For example, mobile device 910 may display a user interface 950 of the image hosting application. The content sharing application may be closed temporarily and its last state may be saved by mobile device 910.

User interface 950 may display an authorization screen of the image hosting application. User interface 950 may include transaction details 952, which may include some or all information included in transaction details 922 displayed by user interface 920 of the content sharing application. In one exemplary case, transaction details 952 may include the content name, “Hawaii Summer 2015.” User interface 950 may also include a personal identifier request 954 requesting a personal identifier from the user. The personal identifier may be any suitable identifier that can uniquely identify the user. In some embodiments, the personal identifier may be a biometric identifier (e.g., fingerprint, voiceprint, retinal scan, etc.). In other embodiments, the personal identifier may be any combination of characters and numbers (e.g., passcode, password, etc.). The personal identifier request 954 may be any combination of one or more of drawings, images, text, or audio that may indicate a request for the personal identifier to the user.

The user may enter their personal identifier to a reader 960 on mobile device 910. In some embodiments, reader 960 may be a biometric reader. The biometric reader may be implemented with any combination of hardware and software that may detect and process the personal identifier. In an exemplary case, reader 860 may be a hardware button of mobile device 910 that may serve as a fingerprint reader. The user may place their finger onto reader 960 enabling input of their personal identifier to mobile device 910, which may then transmit the personal identifier to the image hosting application. The image hosting application may verify the personal identifier and content in the cloud account may be accessed and uploaded to the content sharing application.

While embodiments above describe the transaction being compatible with a single content provider, embodiments are not so limited. For example, there may be multiple accounts of the user, which may or may not be hosted by the image hosting application of FIG. 9, which may have content available for the user to utilize via the cloud account. Other suitable content providers may include social media sites, other image and video hosting applications, and mail host servers. In this case, upon the user activating input element 930, user interface 920 may present the user with the multiple account options in any suitable manner. For example, account identifiers corresponding to the multiple accounts may be presented in a scrollable list, group of tiles, carousel of items, or any other suitable manner. The user may select an account identifier associated with an account to utilize for the transaction. Subsequently, alert notification 940 may be displayed on user interface 920.

### I. Exemplary Computer System

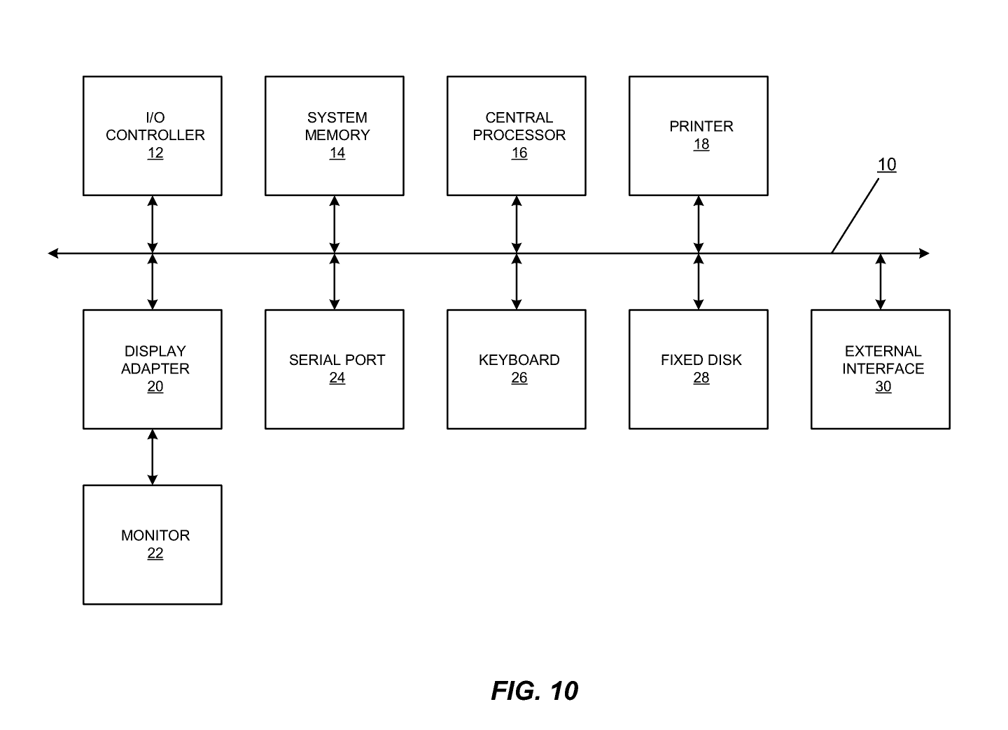

FIG. 10 is a high level block diagram of a computer system that may be used to implement any of the entities or components described above. The subsystems shown in FIG. 10 are interconnected via a system bus 10. Additional subsystems such as a printer 18, keyboard 26, fixed disk 28 (or other memory comprising computer readable media), monitor 22, which is coupled to display adapter 20, and others are shown. Peripherals and input/output (I/O) devices, which couple to I/O controller 12 (which can be a processor or other suitable controller), can be connected to the computer system by any number of means known in the art, such as serial port 24. For example, serial port 24 or external interface 30 can be used to connect the computer apparatus to a wide area network such as the Internet, a mouse input device, or a scanner. The interconnection via system bus allows the central processor 16 to communicate with each subsystem and to control the execution of instructions from system memory 14 or the fixed disk 28, as well as the exchange of information between subsystems. The system memory 14 and/or the fixed disk 28 may embody a computer readable medium. In some embodiments, the monitor 22 may be a touch sensitive display screen.

A computer system can include a plurality of the same components or subsystems, e.g., connected together by external interface 30 or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a server computer, user data of a user conducting a transaction with a computing device from a resource provider server computer;
determining, by the server computer, account data of the user by comparing the user data and enrollment data without receiving account information from the user during the transaction;
sending, by the server computer, account identifiers for the account data to the computing device;
receiving, by the server computer, a selection of an account identifier from the account identifiers; and
sending, by the server computer, at least a portion of the account data corresponding to the selected account identifier to the resource provider server computer to utilize for the transaction.

2. The method of claim 1, further comprising:
receiving, by the server computer prior to the transaction, the enrollment data from the computing device;
sending, by the server computer, a request for the account data of the user to an authorization computer;
receiving, by the server computer, the account data from the authorization computer; and
storing, by the server computer, the account data in association with the enrollment data.

3. The method of claim 1, wherein the user data includes one or more alias identifiers associated with the user.

4. The method of claim 2, wherein the computing device is a mobile device and wherein the enrollment data is received from a mobile application associated with the authorization computer.

5. The method of claim 4, wherein the user conducts the transaction using a mobile application associated with the resource provider server computer.

6. The method of claim 5, wherein the mobile application associated with the resource provider server computer receives a request for a personal identifier of the user from the mobile application associated with the authorization computer before the at least a portion of the account data is sent to the resource provider server computer.

7. The method of claim 6, wherein the personal identifier is a biometric identifier.

8. A server computer comprising:
a processor; and
a computer-readable medium coupled to the processor, the computer-readable medium comprising code, executable by the processor, for performing a method comprising:
receiving, by a server computer, user data of a user conducting a transaction with a computing device from a resource provider server computer;
determining, by the server computer, account data of the user by comparing the user data and enrollment data without receiving account information from the user during the transaction;
sending, by the server computer, account identifiers for the account data to the computing device;
receiving, by the server computer, a selection of an account identifier from the account identifiers; and
sending, by the server computer, at least a portion of the account data corresponding to the selected account identifier.

9. The server computer of claim 8, the method further comprising:
receiving, by the server computer prior to the transaction, the enrollment data from the computing device;
sending, by the server computer, a request for the account data of the user to an authorization computer;
receiving, by the server computer, the account data from the authorization computer; and
storing, by the server computer, the account data in association with the enrollment data.

10. The server computer of claim 8, wherein the user data includes one or more alias identifiers associated with the user.

11. The server computer of claim 9, wherein the computing device is a mobile device and wherein the enrollment data is received from a mobile application associated with the authorization computer.

12. The server computer of claim 11, wherein the user conducts the transaction by a mobile application associated with the resource provider server computer.

13. The server computer of claim 12, wherein the mobile application associated with the resource provider server computer receives a request for a personal identifier of the user from the mobile application associated with the authorization computer before the at least a portion of the account data is sent to the resource provider server computer.

14. The server computer of claim 13, wherein the personal identifier is a biometric identifier.

15. A method comprising:
contacting, by a computing device, a resource provider server computer to conduct a transaction, wherein the resource provider server computer obtains user data associated with a user;
receiving, by the computing device, an indication from the user to communicate with an intermediary server computer, wherein the resource provider server computer transmits the user data to the intermediary server computer, and wherein the intermediary server computer determines account data of the user by comparing the user data and enrollment data without receiving account information from the user during the transaction;
receiving, by the computing device, account identifiers for the account data;
receiving, by the computing device, a selection of an account identifier from the account identifiers; and
transmitting, by the computing device, the selected account identifier to the intermediary server computer, wherein the intermediary server computer sends at least a portion of the account data corresponding to the selected account identifier to the resource provider server computer to utilize for the transaction.

16. The method of claim 15, further comprising:
prompting, by the computing device prior to the transaction, the user to enroll with the intermediary server computer;
receiving, by the computing device, the enrollment data from the user;
receiving, by the computing device, a personal identifier from the user;
verifying, by the computing device, that the personal identifier is valid; and
sending, by the computing device, the enrollment data to the intermediary server computer.

17. The method of claim 16, wherein the computing device is a mobile device and wherein the personal identifier is a biometric identifier.

18. The method of claim 16, wherein the computing device is a mobile device and wherein the enrollment data is received from a mobile application associated with an authorization computer.

19. The method of claim 18, wherein the user conducts the transaction by a mobile application associated with the resource provider server computer.

20. The method of claim 19, wherein the mobile application associated with the resource provider server computer receives a request for a personal identifier of the user from the mobile application associated with the authorization computer before the at least a portion of the account data is sent to the resource provider server computer.
